(19) United States
(12) Patent Application Publication
(10) Pub. No.: US 2012/0141753 A1
(43) Pub. Date: Jun. 7, 2012

(54) ADHESIVE FILM LAYER FOR PRINTED CIRCUIT BOARD APPLICATIONS

(76) Inventor: Christopher A. Hunrath, (US)

(21) Appl. No.: 13/309,513

(22) Filed: Dec. 1, 2011

Related U.S. Application Data
(60) Provisional application No. 61/418,825, filed on Dec. 1, 2010.

(51) Int. Cl. C09J 7/02; B32B 15/08; C09J 139/04

(52) U.S. Cl. 428/212; 524/540; 428/355 R; 428/354; 428/457

(57) ABSTRACT

One or more embodiments contained herein disclose an adhesive layer for printed circuit board (PCB) applications. The improved adhesive film layer may comprise a benzoxazine resin and a phenoxy resin. According to some embodiments, the improved adhesive film layer may be coated onto a polyester release sheet.

### CROSS-REFERENCE TO RELATED APPLICATIONS

This application claims the benefit of priority under 35 U.S.C §119(e) of U.S. Provisional Application No. 61/418,825 filed on Dec. 1, 2010 and entitled “IMPROVED ADHESIVE FILM LAYER FOR RIGID PRINTED CIRCUIT BOARDS,” which is hereby incorporated herein by reference in its entirety and is to be considered a part of this specification.

### BACKGROUND

1. Field

The disclosure herein relates to printed circuit boards, and more particularly, adhesive resin film layers for use in the manufacture of rigid printed circuit boards. The Appendix attached to the aforementioned provisional is incorporated by reference in its entirety as part of the specification.

2. Description of the Related Art

Printed circuit boards (PCB) comprise one or more layers of electrically conductive material such as copper and one or more electrically insulating layers such as dielectrics. Multilayer PCBs typically comprise two or more inner and/or surface conductive layers formed over and separated by a plurality of insulating layers with holes, vias, and through holes providing electrical connection between the various inner conductive layers and other inner conductive layers and/or the surface conductive layers.

Several aspects of the PCB manufacturing and assembly processes subject PCB components to strain or stress (e.g., mechanical, thermal, physical, chemical, and the like). For example, manufacturing exposes PCBs to a range of temperatures, including high soldering temperatures which have increased even more in response to the industry's recent adoption of lead-free processes. Strain can cause defects in components, resulting in electrical and/or mechanical failure. For example, thermal strain arising from increasing temperatures can cause cracks in the PCB components, including pad cratering, a type of crack typically occurring in insulating layers that engage surface conductive layers.

Adhesive film layers are used in the PCB assembly process to bind various conductive and insulating layers together. Currently used adhesive film layers are impregnated with fiberglass or other fillers which can cause plating defects, slow laser drilling, provide pathways for filament growth, and prevent via pitch reduction. There is a need for adhesive film layers free of fiberglass which are more stable and damage resistant that allow for faster laser drilling, reduction of plating defects such as folds in both laser and mechanically drilled vias which makes vias easier to copper fill, eliminate filament growth pathways, and allow for significant via pitch reductions.

### SUMMARY

In an embodiment, a composition of matter consisting of benzoxazine resin and phenoxy resin. In an embodiment, a composition of matter consisting of benzoxazine resin and phenoxy resin is manufactured in an advanced process to form a film.

In certain embodiments, a component for manufacturing rigid printed circuit boards comprises an adhesive film layer comprising a first surface and a second surface, wherein the adhesive film layer comprises benzoxazine resin and phenoxy resin; a discardable layer comprising a first surface, wherein the first surface of the discardable layer is attached to the first surface of the adhesive film layer, wherein the discardable layer comprises a polyethylene terephthalate film.

In an embodiment, a device for mounting electrical components comprises: a printed circuit board comprising: a surface conductive layer configured to interface with the electrical components; a strain resistant cap layer configured to engage the surface conductive layer, wherein the strain resistant cap layer comprises polyimide; an adhesive film layer configured to engage the strain resistant cap layer, wherein the adhesive film layer comprises benzoxazine and phenoxy resin; and one or more rigid insulating layers, wherein at least one of the one or more rigid insulating layers extends throughout the entire length of the printed circuit board such that the entire printed circuit board defines a rigid printed circuit board.

In accordance with some embodiments, a method of manufacturing printed circuit boards comprises: providing a component comprising a first surface of a strain resistant cap layer engaging a first surface of a conductive layer, wherein the strain resistant cap layer comprises polyimide; attaching a second surface of the strain resistant cap layer to the first surface of an adhesive film layer, wherein the adhesive film layer comprises benzoxazine and phenoxy resin; and attaching the component to a stack of laminates by a top surface of a first layer of the stack of laminates engaging the second surface of the adhesive film layer, wherein the stack of laminates comprises at least one rigid insulating layer extending throughout the entire length of the printed circuit board to define the printed circuit board comprising entirely rigid portions.

In certain embodiments, a component for manufacturing rigid printed circuit boards comprises an adhesive film layer comprising a first surface and a second surface; a discardable layer comprising a first surface, wherein the first surface of the discardable layer is attached to the first surface of the adhesive film layer; and a strain resistant layer comprising a first surface, wherein the first surface of the strain resistant layer is attached to the second surface of the adhesive film layer, and wherein the strain resistant layer is attached to the first surface of a conductive layer. The strain resistant layer comprises at least two characteristics selected from a group of: ductility of at least about 15%, Tg of at least about 220° C., and tensile strength of at least about 10,000 psi.

In some embodiments, a printed circuit board comprises: a surface conductive layer configured to interface with the electrical components, wherein the surface conductive layer comprises rolled-annealed copper; a strain resistant cap layer configured to engage the surface conductive layer, wherein the strain resistant cap layer comprises polyimide; an adhesive film layer configured to engage the strain resistant cap layer, wherein the adhesive film layer comprises benzoxazine and phenoxy resin; and one or more rigid insulating layers, wherein at least one of the one or more rigid insulating layers extends throughout the entire length of the printed circuit board such that the printed circuit board defines a rigid printed circuit board. Various embodiments disclosed herein contemplate certain more stable and damage-resistant PCB components for use with rigid PCBs that may substantially increase the yield of rigid PCBs while possibly reducing defects such as voids and cracks and increasing the structural integrity of the rigid PCBs and portions of rigid PCBs such as junctions between insulating layers and surface conductive layers.

In some embodiments, a rigid circuit board comprises a surface conductive layer that engages a strain resistant cap layer, which engages an adhesive film layer. In an embodiment, a component for manufacturing printed circuit boards such as rigid printed circuit boards comprises a surface copper layer, a strain resistant layer, wherein the strain resistant layer comprises polyimide, and an adhesive film layer, wherein the adhesive film layer comprises benzoxazine and phenoxy resin. In a certain embodiment, a rigid PCB comprises one or more strain resistant layers combined using one or more adhesive film layers. Further still, the printed circuit board in one embodiment comprises: a surface conductive layer configured to interface with the electrical components, wherein the surface conductive layer comprises rolled-annealed copper; a strain resistant cap layer configured to engage the surface conductive layer, wherein the strain resistant cap layer comprises ductility of at least 15% and tensile strength of at least 10,000 psi; an adhesive film layer, wherein the adhesive film layer comprises benzoxazine and phenoxy resin; and one or more rigid insulating layers, wherein at least one of the one or more rigid insulating layers extends throughout the entire length of the printed circuit board such that the printed circuit board defines a rigid printed circuit board.

In other embodiments, a composition of matter comprises an uncured benzoxazine resin, the uncured benzoxazine resin being present in the composition in an amount in the range of 75% by weight to 95% by weight based on the total weight of the composition; and an uncured phenoxy resin, the uncured phenoxy resin being present in the composition in an amount in the range of 5% by weight to 25% by weight based on the total weight of the composition. Further, the composition comprises a cured benzoxazine resin, the cured benzoxazine resin being present in an amount in the range of 5% by weight to 25% by weight based on the total weight of the composition. In an embodiment, the uncured benzoxazine resin is present in an amount of about 85% or 80% by weight based on the total weight of the composition.

In some embodiments, a layered film comprises an adhesive film layer comprising an uncured benzoxazine resin, the uncured benzoxazine resin being present in the adhesive film layer in an amount in the range of 75% by weight to 95% by weight based on the total weight of the adhesive film layer; and an uncured phenoxy resin, the uncured phenoxy resin being present in the adhesive film layer in an amount in the range of 5% by weight to 25% by weight based on the total weight of the adhesive film layer. Further, the layered film comprises a carrier layer comprising a sheet comprising polyester having a surface, wherein the adhesive film layer is disposed on the surface of the sheet comprising polyester. In some embodiments, the sheet comprising polymer comprises polyethylene terephtalate.

### BRIEF DESCRIPTION OF THE DRAWINGS

These and other features will now be described with reference to the drawings summarized below. These drawings and the associated description are provided to illustrate one or more embodiments described in the present patent application and not to limit the scope of the disclosed embodiments.

FIG. 1 depicts an embodiment of a multilayer rigid printed circuit board.

FIG. 2 illustrates another embodiment of a multilayer rigid printed circuit board comprising via holes and conductive plates.

FIG. 3A illustrates a printed circuit board comprising ball grid array (BGA) packaging.

FIG. 3B is a cross sectional view of an electrical component mounted on a printed circuit board to form a printed circuit board assembly.

FIG. 3C illustrates an embodiment of a printed circuit board showing a cap layer engaging a surface conductive layer.

FIG. 3D illustrates an embodiment of a printed circuit board showing a cap layer comprising a defect engaging a surface conductive layer.

FIG. 3E illustrates an embodiment of a printed circuit board showing a cap layer comprising another defect engaging a surface conductive layer.

FIG. 4 illustrates an embodiment of a rigid printed circuit board comprising strain resistant layers and adhesive film layers.

FIG. 5A illustrates an embodiment of a component of a rigid printed circuit board comprising strain resistant layers and adhesive film layers.

FIG. 5B illustrates an embodiment of a component of a rigid printed circuit board comprising strain resistant layers, adhesive film layers, and discardable layers.

FIG. 6 illustrates an embodiment of a multilayer printed circuit board stack.

FIG. 7A illustrates an embodiment of a component for use in manufacturing printed circuit boards comprising a discardable layer, strain resistant layers, and adhesive film layers.

FIG. 7B illustrates another embodiment of a component for use in manufacturing printed circuit boards comprising a discardable layer, a strain resistant layer, and an adhesive film layer.

FIG. 8 is a table listing material characteristics of example strain resistant materials and other insulating materials.

FIG. 9 is a table comparing expansion characteristics of example strain resistant materials and other dielectric materials.

### DETAILED DESCRIPTION

### A. General Description of Non-Limiting Embodiments

The terms “rigid printed circuit boards,” “PCBs,” and “electrical interconnect systems,” as used in the present patent application, are broad terms, shall have their ordinary meaning in the industry and are broadly defined and comprise, without limitation, any and all systems that provide, among other things, mechanical support to electrical components, electrical connection to and between these electrical components, combinations thereof, and the like. Each term individually is entitled to its own ordinary meaning. PCBs comprise systems that generally include a base platform to support the electrical components (for example, a thin board of insulating material) and conductors such as conductive pathways, surfaces, solderable attachments, and the like to provide an electrical interconnection between the electrical components. PCBs can employ a broad range of technologies to support the electrical components (for example, through-hole, surface-mount, mixed-technology, components mounted on one or both sides, etc.) and can comprise a wide range of single or multilayer constructions (for example, single-sided, double-sided, multilayer, flexible, rigid-flex, stripline, etc). The various embodiments herein can apply to PCBs existing at any stage of the PCB manufacturing process, including, by way of non-limiting examples, partially incomplete PCBs lacking one or more PCB components typically present in more complete PCBs such as, for example, insulating layers, conductive circuit patterns, conductive plates, via holes, and the like. As used throughout this application, the term “rigid PCB” includes its standard meaning in the industry and also defines PCBs having no bendable portions. As defined herein, “partially rigid PCBs” broadly refers to interconnect systems comprising at least some rigid and non-bendable portions. Layers belonging to the rigid and non-bendable portions of rigid or partially rigid PCBs can be at least substantially coplanar and may lie in the same plane (e.g., horizontal plane, vertical planes, planes therebetween, etc.) and can be configured to maintain a coplanar structure in operation. PCBs and rigid PCBs can comprise one or more rigid insulating layers. “PCB assembly” broadly refers to printed circuit board systems on which electrical components are partially, substantially, or fully mounted (e.g., electrically attached or connected).

The terms “insulating layer,” “dielectric layer,” and “dielectric substrate” are broadly interpreted herein, include their standard meaning in the industry, and describe, without limitation nonconductive PCB layers generally configured to resist or substantially resist the flow of electricity and to provide physical support for, among others, conductive layers and electrical components. The term “rigid” as used in connection with PCB insulating layers (e.g., rigid insulating layers, rigid dielectrics, etc.) is broadly defined, shall have its ordinary meaning in the industry, and describes, without limitation, insulating layers comprising ordinary “rigid materials” including, without limitation, materials that are typically non-bendable and reinforced with fiberglass, papers, cotton fabric, asbestos sheet, glass in various forms such as cloth and continuous filament mat, ceramic material, molybdenum, various types of plastics, etc. Several other rigid materials or mixes of rigid materials can be used to produce rigid insulating layers, including prepregs (short for preimpregnated) such as, for example, flame retardant (FR) 2 (cellulose paper impregnated with phenolic resin), FR-3 (cotton paper impregnated with epoxy), FR-4 (epoxy-resin impregnated woven glass cloth), FR-5 (woven glass impregnated with epoxy), etc. Rigid layers comprise rigid materials generally used to manufacture rigid PCBs or rigid portions of partially rigid PCBs.

The term “adhesive film layers” is used broadly herein, includes its standard meaning in the industry, and describes, without limitation, nonconductive PCB layers generally configured to bind various other layers together, to provide physical support for, among others, conductive layers and electrical components, and comprising, among others, one or more characteristics that can endure more strain (e.g., mechanical, thermal, physical, chemical, and the like) and/or can be more stable (e.g., thermally, chemically, physically, etc) than ordinary adhesive film layers, including rigid adhesive film layers as described herein. Adhesive film layers comprise a broadly defined array of “adhesive materials,” including, without limitation, thermoset and/or thermoplastic plastics, such as, for example, benzoxazines, phenoxy resins, polyethers, polyimides, polyesters, fluorinated hydrocarbons, polymers, polyacrylates, liquid crystal polymers, synthetic fibers, aramids, fluorocarbons, etc. Adhesive film layers can also comprise a mixture of one or more of the thermoset and/or thermoplastic plastic materials or a mixture of one or more of the plastic materials with other materials (e.g., fillers, hardeners, etc.).

As used herein, “strain resistant layers” is defined broadly, has its ordinary meaning in the industry, and refers to, without limitation, insulating layers for manufacturing printed circuit boards, including rigid and partially rigid PCBs, comprising, among others, one or more characteristics that can endure more strain (e.g., mechanical, thermal, physical, chemical, and the like) and/or can be more stable (e.g., thermally, chemically, physically, etc) than ordinary insulating layers, including rigid insulating layers as described herein. Strain resistant layers comprise a broadly defined array of “strain resistant materials,” including, without limitation, thermosetting and/or thermoplastic plastics, such as, for example, polyimide, polyester, fluorinated hydrocarbon, polymers, polyacrylate, liquid crystal polymer, synthetic fibers, aramids, fluorocarbons, etc. Strain resistant layers can also comprise a mixture of one or more of the thermosetting and/or thermoplastic plastic materials or a mixture of one or more of the plastic materials with other materials (e.g., fillers, hardeners, etc.).

“Cap layer,” as used herein, is broadly defined, has its ordinary meaning in the industry, and describes, without limitation, dielectric substrates and insulating layers that interface with or engage the outermost conductive layers, also referred to herein as “surface conductive layers,” such as, for example, surface copper pads. “Surface conductive layer,” “outer conductive layer,” or “surface layer” used in connection with PCB conductive layers as used in the present patent application, are broad terms, shall have their ordinary meaning in the industry and broadly refer, without limitation, to the outermost conductive layers of PCBs, such as, for example, surface copper layers and etched surface conductive pads generally configured to engage electrical devices mounted on the PCBs, such as, for example, electrical components. Each term individually is entitled to its own ordinary meaning. “Electronic” or “electrical” components as used in the present patent application, are broad terms, shall have their ordinary meaning in the industry, and broadly describe, without limitation, any PCB-mountable device capable of handling electricity for which PCBs are designed to provide, among others, physical support and/or electrical connection and without limitation include electrical devices, electronic devices, electronic circuits, electrical elements, integrated circuits, hybrid systems, and the like.

The term “layer” as used in the present patent application, is a broad term, shall have its ordinary meaning in the industry, is broadly defined, and implies, without limitation, a position in the cross section (profile) of PCBs or components of PCBs. A layer in a PCB may be continuous or discontinuous, and may or may not be planar or substantially planar. For example, a PCB may comprise an inner or outer conductive discontinuous layer such as an etched printed circuit layer. As used in relation to one PCB layer in connection with another PCB layer, the terms “engage” or “attach” or “over” (e.g., as in one layer over another layer) are broadly defined, shall have their ordinary meaning in the industry, and are broadly used, without limitation, to describe a layer or portions of the layer directly or indirectly connected or attached to another layer or portions of the other layer. Each term individually is entitled to its own ordinary meaning. Non-limiting examples of an indirect connection include, for example, a layer in a PCB connected or attached to another layer through an intermediate layer, such as, for example, a mask, a coating layer, a thin film, soldering material, and the like. Similarly, “forming,” “depositing,” “positioning,” or “providing,” as used herein in connection with creating or positioning one layer over or on another layer, are broad terms, shall have their ordinary meaning in the industry, and generally disclose, without limitation, arranging or creating PCB layers such that at least portions of one layer are directly or indirectly engaging at least portions of the other layer. A rigid layer “extending” throughout the entire length of the PCB defines a layer generally provided over the length of the PCB (e.g., may or may not be continuous, may or may not have same boundaries with the PCB, etc.) such that the PCB is a rigid PCB.

As used herein, the terms “pre-form” or “pre-forming” PCB layer components or layers to be used with PCBs as used in the present patent application, are broad terms, shall have their ordinary meaning in the industry, and broadly define, without limitation, a discontinuity between manufacturing the components and manufacturing PCBs using the pre-formed components such that the component manufacturing and the PCB manufacturing qualify as “independent manufacturing processes.” A non-limiting example of independent manufacturing processes includes manufacturing PCBs using a component manufactured by an entity different from the entity manufacturing the PCBs, such as, without limitation, 3^{rd} parties (e.g., original equipment manufacturers, distributors, wholesalers, discount sellers, suppliers, retailers, etc.), affiliates, subsidiaries, parent entities, licensors/licensees, other legally different entities, combinations thereof, and the like. PCB “manufacturing” is broadly defined herein, shall have its ordinary meaning in the industry, and includes, without limitation, all stages of the PCB manufacturing and assembly process, including, for example, preparing or obtaining materials to make PCB layers, providing at least a first PCB layer, processing one or more PCB layers to form circuit patterns separated by insulating layers, assembling a PCB by mounting an electrical component onto a partially, substantially or fully completed PCB, testing a PCB assembly package comprising electric devices mounted thereon, etc. Various embodiments herein describing manufacturing rigid PCBs are also applicable to manufacturing rigid portions of partially rigid PCBs.

As used herein, “curing” or “cured” or “cure” as used in the present application are broad terms, shall have their ordinary meaning in the industry, and broadly define, without limitation, the process of polymerizing, toughening and/or hardening polymer material by combining polymers such as epoxies with curing agents or by subjecting polymers to other curing processes such as heat, pressure, radiation, or the like. Polymer material can be uncured, partially cured in which the hardening process has begun but is not complete, or fully cured wherein the resin in the polymer material has substantially or completely hardened.

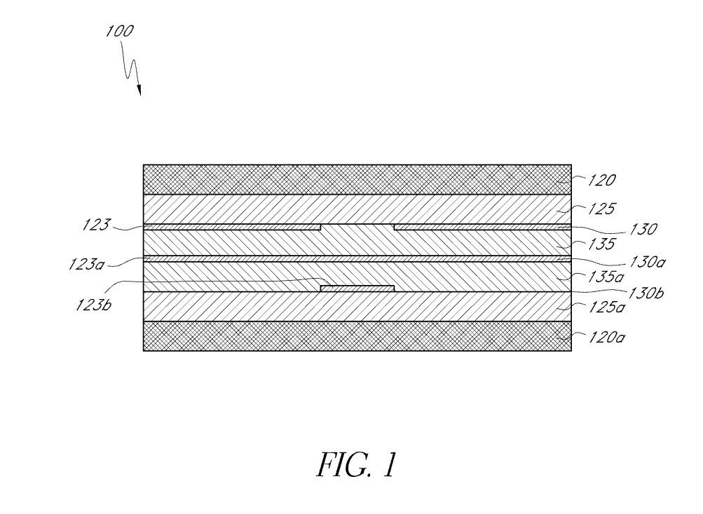

Referring now to FIG. 1, an embodiment of a multilayer rigid printed circuit board (PCB) 100 is illustrated. The PCB 100 comprises first and second conductive outer or surface layers 120, 120a, first and second insulating layers 125, 125a, first, second, and third conductive inner layers 130, 130a, 130b, and first and second insulating inner layers 135, 135a. The first and second insulating layers 125, 125a of FIG. 1 engage the first and second surface conductive layers 120, 120a and, therefore, are cap layers. The conductive inner layers 130, 130a, 130b can be etched to form first, second, and third circuit patterns 123, 123a, 123b.

As illustrated in FIG. 1, the first surface conductive layer 120 is over the first insulating layer 125 and the first insulating layer 125 is provided over the top surface of the first circuit pattern 123. The first circuit pattern 123a is over the top surface of the first insulating inner layer 135, the latter of which is positioned over the second circuit pattern 123b, which in turn is over the top surface of the second insulating inner layer 135a. As shown in FIG. 1, the third circuit pattern 123b is over the top surface of the second insulating layer 125a and the second insulating layer 125a is provided over the second surface conductive layer 120a.

The surface conductive layers 120, 120a and/or the circuit patterns 123, 123a, 123b can comprise any suitable conductive metals, such as, for example, copper, gold, aluminum, nickel, kovar, steel, resistance alloys, etc. PCB conductive layers are typically made of thin copper foil. As shown in FIG. 1, at least one of the insulating layers 125, 125a and/or the insulating inner layers 135, 135a comprises an ordinary insulating layer comprising a wide array of rigid materials such as epoxy resin, FR-3, FR-4, etc. In certain embodiments, at least one of the insulating layers 125, 125a and/or the insulating inner layers 135, 135a comprising rigid material is substantially coplanar with at least one of the surface conductive layers 120, 120a such that the PCB 100 is a rigid PCB. In certain embodiments, the at least one of the insulating layers 125, 125a and/or the insulating inner layers 135, 135a comprising rigid material is substantially coextensive (e.g., cross sectional length) with at least one of the surface conductive layers 120, 120a. In various embodiments, the PCB 100 comprises at least one rigid insulating layer (e.g., the first and second insulating layers 125, 125a, the first and second insulating inner layers 135, 135a, or another insulating layer not shown) extending through the entire length of the PCB 100 such that the PCB 100 is a rigid PCB. Dielectric materials, including the insulating layers 125, 125a and the insulating inner layers 135, 135a can be selected based on properties such as, for example, thermal stability, dielectric constant, flexibility, tensile strength, and dimensional stability.

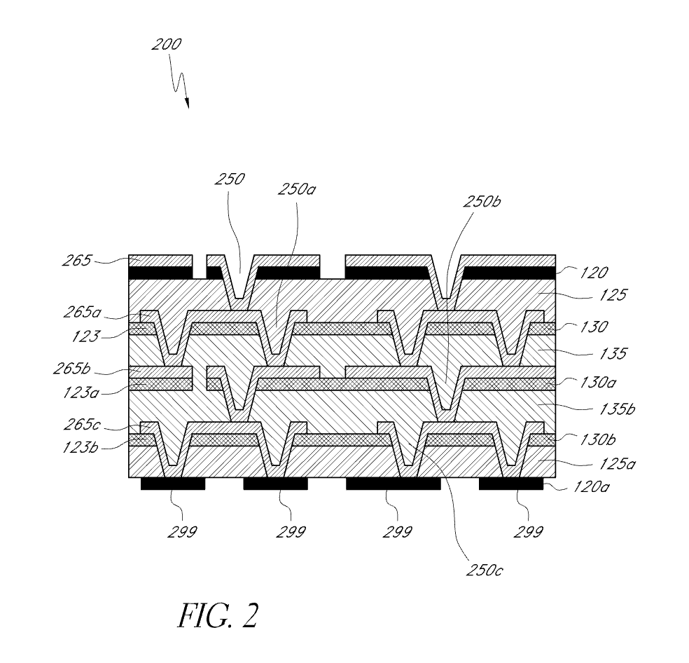

FIG. 2 illustrates another embodiment of a multilayer PCB 200 disclosing the PCB 100 of FIG. 1 further comprising first, second, third, and fourth levels of via holes 250, 250a, 250b, 250c and conductive plates 265, 265a, 265b, 265c. The via holes 250, 250a, 250b, 250c and the conductive plates 265, 265a, 265b, 265c, the latter being at least partially over some portions of the via holes 250, 250a, 250b, 250c, the surface conductive layers 120, 120a, and the circuit patterns 123, 123a, 123b, generally are configured to electrically connect various conductive layers of the PCB 200, as will be discussed below.

As illustrated in FIG. 2, the first level via holes 250 are shown penetrating the first surface conductive layer 120 and the first insulating layer 125. In FIG. 2, the first layer via holes 250 and some portions of the first surface conductive layer 120 are coated with the conductive plate 265. The first level via holes 250 and the conductive plate 265 connect some portions of the surface conductive layer 120 with some portions of the first conductive inner layer 130. The second layer of via holes 250a are shown penetrating the first conductive inner layer 130 and the first insulating inner layer 135. The second layer via holes 250a and some portions of the first conductive inner layer 130 are coated with the conductive plate 265a. The second layer via holes 250a and the conductive plate 265a connect some portions of the first conductive inner layer 130 with some portions of the second conductive inner layer 130a.

Still with reference to FIG. 2, the third layer of via holes 250b are shown penetrating the second conductive inner layer 130a and the second insulating inner layer 135b. The third layer via holes 250b and some portions of the second conductive inner layer 130a are coated with the conductive plate 265b and connect some portions of the second conductive inner layer 130a with some portions of the third conductive inner layer 130b. The fourth layer via holes 250c penetrate the third conductive inner layer 130b and the second insulating layer 125a. The fourth layer via holes 250c and portions of the third conductive inner layer 130b are coated with the conductive plate 265c and connect some portions of the third conductive inner layer 130b with some portions of the second surface conductive layer 120a. In some embodiments, the first surface conductive layer 120, the second surface conductive layer 120a, or both the first and second surface conductive layers 120, 120a are etched to create pads 299, for example, to electrically connect an electrical component such as a semiconductor chip (not shown) with the PCB 200.

As shown in FIGS. 1 and 2, the PCB 100 and the PCB 200 are provided as non-limiting illustrative embodiments and although the figures show PCBs comprising four insulating layers (the first and second insulating layers 125, 125a and the first and second insulating inner layers 135, 135a) and five conductive layers (the first and second surface conductive layers 120, 120a and the first, second, and third circuit patterns 123, 123a, 123b) arranged in the configurations disclosed therein, the various embodiments and features disclosed throughout this application can be used in connection with PCBs comprising a different number (for example, more or fewer than five conductive layers and/or four insulating layers) and a different arrangement of conductive and/or insulating layers. For example, although the via holes 250, 250a, 250b, 250c of PCB 200 penetrate only a single layer of electrically conductive layer and a single layer of insulating layer, the via holes 250, 250a, 250b, 250c in other embodiments can be configured to comprise varying lengths penetrating more or fewer layers. In one embodiment, a solder resist layer can be further deposited on the top surface of one or both of the outer most conductive layers 120, 120a. In some embodiments, as least some of the via holes 250, 250a, 250b, 250c can be at least partially filled with solder resist material. In certain embodiments, the PCB 200 can comprise one or more through-holes penetrating one or more of the layers of the PCB 200 to accommodate insertion of electrical component leads. In some embodiments, at least one of the first and second insulating layers 125, 125a or the first and second insulating inner layers 135, 135a comprises rigid material. In certain embodiments, portions of the at least one of the first and second insulating layers 125, 125a or the first and second insulating inner layers 135, 135a comprising rigid material are coplanar with some portions of the at least one of the surface conductive layers 120, 120a such that the PCB 200 comprises at least some rigid portions comprising the rigid portions of a partially rigid PCB. In certain embodiments, substantial portions of the at least one of the first and second insulating layers 125, 125a or the first and second insulating inner layers 135, 135a comprising rigid material are coplanar with the at least one of the surface conductive layers 120, 120a such that the PCB 400 is a rigid PCB. In various embodiments, the PCB 400 comprises at least one rigid insulating layer (e.g., the first and second insulating layers 125, 125a, the first and second insulating inner layers 135, 135a, or another insulating layer not shown) extending through the entire length of the PCB 400 such that the PCB 400 is a rigid PCB. In some embodiments, the PCB 400 comprises a plurality of rigid insulating layers, some of which extend substantially less than the entire length of the PCB 400 (e.g., half, a third, etc.), arranged in a manner such that the combination of the plurality of rigid insulating layers makes the PCB 400 a rigid PCB (e.g., a rigid insulating layer extending roughly through half the length of the PCB 400, another rigid layer extending roughly through the remaining half, etc.).

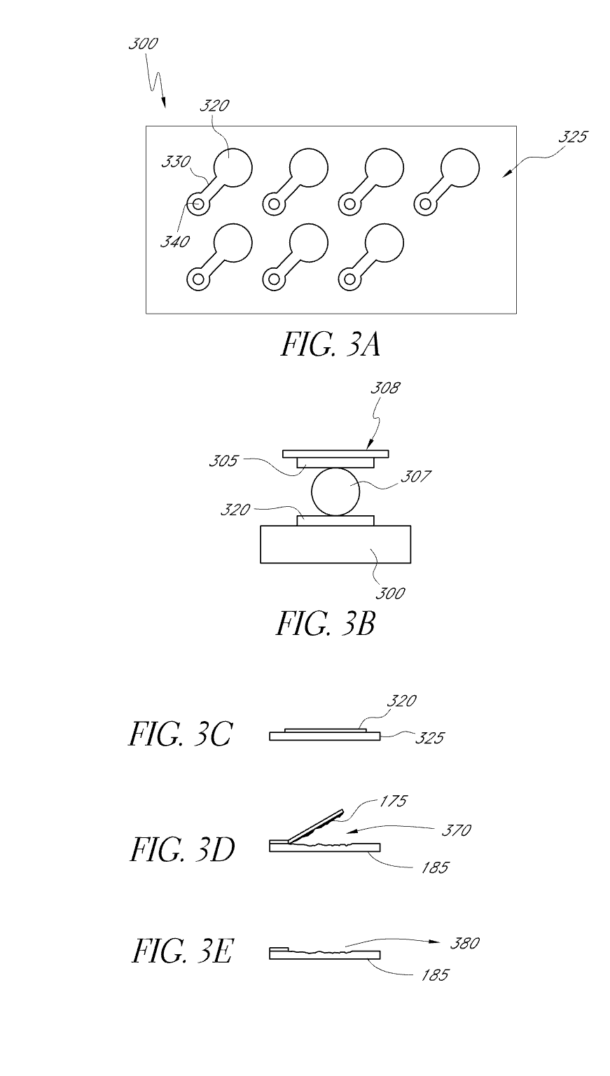

FIGS. 3A-3E include depictions of various embodiments illustrating an example defect that can be caused by, among others, the strain (e.g., thermal strain) put on PCBs during the manufacturing process. FIG. 3A is a top plan view of the top surface 325 of a PCB 300 comprising, for example, one or more of the PCBs 200 of FIG. 2. The top surface 325 has thereon a simplified dog bone design comprising conductive pads 320, plated via holes 340, and connectors 330. The PCB 300 comprises a ball grid array (BGA) mounting technology wherein the array of conductive pads 320 are configured to connect to corresponding conductive pads of surface mountable electrical components (not shown) to electrically attach or mount the electrical components with the PCB 300. In some embodiments, the PCB 300 can be configured to comprise different electrical component packaging technologies such as, without limitation, Dual In-line Packaging (DIP), Pin Grid Array (PGA), Leadless Chip Carrier (LCC), Flip-chip BGA (FCBGA), Plastic Quad Flat Pack (PQFP), Small-Outline Integrated Circuit (SOIC), Plastic Leaded Chip Carrier (PLCC), System in Package (SIS), combinations thereof, and the like.

FIG. 3B shows a cross-section view of portions of an electrical component 308, soldering material 307, and a portion of the PCB 300 of FIG. 3A. A conductive chip pad 305 is attached to the electrical component 308. For simplicity, the PCB 300 of FIG. 3B shows only one of the conductive pads 320 attached to the PCB 300 of FIG. 3A. As shown in FIG. 3B, the conductive chip pad 305 of the electrical component 308 can be electrically connected to the conductive pad 320 of the PCB 300 using the soldering material 307. The assembly can be heated, for example using a reflow oven or an infrared heater, to melt the solder ball 307 and to thereby mechanically couple the electrical component 308 with the PCB 300. Once coupled, the electrical component 308 and the PCB 300 are electrically connected, and electric signals from the conductive pad 320 can flow to the electrical component 308 through the soldering material 307 and the electrically conductive chip pad 305.

During the manufacturing of PCBs, an electrical component assembly process, or normal operation of PCBs, cracks can occur on one or more layers of the PCBs. One cause of such cracks is the considerable thermal stress (e.g., including mechanical stress arising from changes in temperature) to which PCBs are subjected, for example, during the manufacturing process including heating of the soldering material. Various materials used in the assembly processes, such as insulating layers, conductive layers, soldering metals, and electrical components can have different coefficients of thermal expansion (CTE), potentially causing these materials to expand and contract at different rates in response to changes in temperature. As such, thermal stress during the PCB assembly process can arise from mismatches in CTE, both between the electrical components, including soldering material, and the PCB boards onto which the electrical components are mounted, and between the different materials which make up the PCB. In the case of a type of crack called pad cratering, thermal mismatch or Coefficient of Thermal Expansion (CTE) mismatch, for example between cap layers and surface conductive layers, can cause a defect such as a crack in the cap layers as the cap layers and the surface conductive layers respond (e.g., expand or contract) to temperature changes at unequal rates. For example, when heat is applied to soldering material 307, CTE mismatch between the conductive pad 320 and portions of the cap layer underneath the conductive pad 320 can cause portions of the cap layers to move relative to the conductive pad 320 (e.g., opposite direction), separating some portions of the cap layer from the conductive pad 320. Pad cratering can cause portions of the PCB to be separated or fall off, resulting in mechanical failure in the PCB, or can create a defect in the flow of electricity in the PCB, causing an electrical failure. In certain embodiments, thermal stress can cause the conductive pads 320 to partially, substantially, or fully separate from the underlying cap layer. The at least partially separated conductive pads 320 can remove portions of the cap layer still attached to portions of the at least partially separated conductive pads 320, thereby creating holes or craters the cap layer from which the at least partially separated conductive pads 320 separate. Strain such as thermal strain can also cause a defect by applying stress to the junction connecting the cap layer and the conductive pad 320 without forming a crack in the cap layer to potentially cause intermittent or thermally sensitive electrical or mechanical failures.

Still with reference to 3B, the recent trend of using lead-free PCB manufacturing processes including lead-free soldering has exacerbated pad cratering. The leading lead-free alloys used in the PCB assembly process such as tin, bismuth, copper, various proprietary mixtures of some of these alloys, and/or other materials have higher melting points than lead-based soldering material, necessitating the use of higher temperatures to melt the soldering material 307 to couple, for example, the semiconductor electrical component 308 and the PCB 300. As CTEs are a function of temperature, the application of higher temperatures to the various layers of the PCB 300 and the electrical component 308 can put even more strain on the PCB 300, the various layers of the PCB 300 (e.g., between insulating and conductive layers), the electrical component 308, and the various layers of the electrical component 308 by increasing differences due to thermal expansion, thereby increasing thermal stress.

Still with reference to 3B, the PCB 300 can also be subjected to more mechanical strain, including during the manufacturing process, as a result of rising manufacturing temperatures. The use of increasing reflow-soldering temperatures can correspondingly increase the hardness of insulating layers, including cap layers, making these insulating layers more brittle and more susceptible to mechanical stress. Further, the leading non-lead based soldering materials typically have harder and stiffer properties than lead-based soldering materials and, therefore, can generate higher mechanical forces on the conductive pads 320 or insulating layers of the PCB 300 including the cap layers engaging the conductive pads 320. Alone or in combination, these factors can increase the frequency of cracks, including pad cratering, that can occur in insulating cap layers engaging the conductive pads 320. In certain embodiments, strain as described herein applies stress to junctions connecting insulating layers and conductive layers, causing defects in the connection (e.g., sever partially or completely, undermine connectivity, etc.) creating electrical or mechanical failures.

FIGS. 3C-3E illustrate an embodiment of pad cratering that can occur, for example, in an insulating layer 325 positioned below surface conductive layers of PCBs, including, for example, the conductive pad 320 of FIG. 3B. Although the pad cratering embodied in FIGS. 3C-3E is shown as occurring in the insulating layer 325 underneath the conductive pad 320 of FIG. 3B, FIGS. 3C-3E illustrate only one embodiment and cracks can occur in different layers, including, without limitation, the insulating inner layers 135, 135a of FIG. 2, and in insulating layers engaging different conductive layers, such as, without limitation, the conductive inner layers 130, 130a, 130b. FIG. 3C shows the conductive pad 320 and the insulating layer 325 (for example, the first insulating layer 125 of FIG. 2) engaging the conductive pad 320 under normal circumstances. FIG. 3D shows the connection between the conductive pad 320 and the insulating layer 325, wherein the insulating layer 325 is beginning to form a crack 370 (pad cratering) as a result of the strain exerted onto the conductive pad 320. As can be seen in FIG. 3D, the crater 370 separates at least one end of the insulating layer 325 into top portion 175 and bottom portion 185. FIG. 3E illustrates a more substantial pad cratering 380 wherein the top portion 175 of the insulating layer 325 is separated from the bottom portion 185, likely causing failure in the PCB 300 or portions of the PCB 300.

During the manufacturing of PCBs, an electrical component assembly process, or normal operation of PCBs, conductive anodic filament failure can occur through one or more insulating layers of the PCB. Conductive anodic filament failure is the growth or electro-migration of copper in a PCB. This filament growth typically bridges two oppositely biased copper layers through one or more insulating layers. This failure can be manifested in four main ways: through hole to through hole, line-to-line, through hole to line, and layer-to-layer. One cause of such filament growth is the use of insulating polymeric layers containing filler materials used for reinforcement such as fiberglass, FR-2, FR-3, etc. The use of polymeric layers containing filler materials used for reinforcement such as fiberglass, FR-2, FR-3, etc, also result in slower laser drilling during the manufacturing of PCBs, and can cause plating defects such as folds in both laser and mechanically drilled vias, making the via difficult to copper fill.

### B. Detailed Descriptions of Non-Limiting Embodiments

Methods and systems for use with manufacturing, assembling, and using PCBs, including rigid and partially rigid PCBs, comprising more stable (e.g., thermally, mechanically, physically, etc.) strain resistant layers and adhesive film layers to resist damage that can arise from strain and/or stress (e.g., mechanical, thermal, physical, and the like) will now be described with reference to the accompanying drawings.

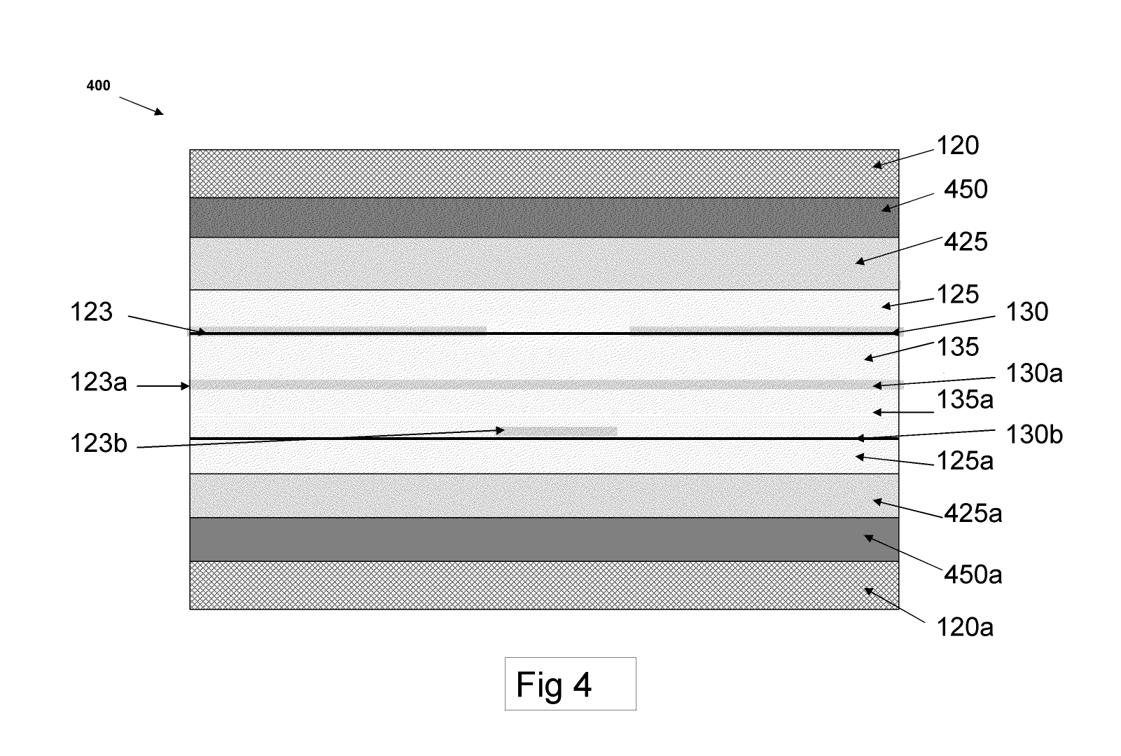

FIG. 4 illustrates a multilayer PCB 400 comprising the PCB 100 of FIG. 1 and further comprising first and second strain resistant layers 450, 450a and first and second adhesive film layers 425 and 425a. The first surface conductive layer 120 is over the first strain resistant layer 450, the latter of which is over the first adhesive film layer 425 which is over the first insulating layer 125. The top surface of the first strain resistant layer 450 engages the first surface conductive layer 120 and the bottom surface of the first strain resistant layer 450 engages the first adhesive film layer 425 which in turn engages the first insulating layer 125. The second strain resistant layer 450a is over the second surface conductive layer 120a and the second adhesive film layer 425a is over the second strain resistant layer 450a. The second strain resistant layer 450a is between the second surface conductive layer 120a and the second adhesive film layer 425a and the first strain resistant layer 450 is between the first surface conductive layer 120 and the first adhesive film layer 425. The second adhesive film layer 425a is between the second insulating layer 125a and the second strain resistant layer 450a. The bottom surface of the second strain resistant layer 450a engages the second surface conductive layer 120a and the top surface of the second strain resistant layer 450a engages the second adhesive film layer 425a. In some embodiments, a pre-formed laminate component comprising the first adhesive film layer 425 engaging the first strain resistant layer 450 engaging the first surface conductive layer 120 or a pre-formed laminate component comprising the second adhesive film layer 425a engaging the second strain resistant layer 450a engaging the second surface conductive layer 450b can be used to manufacture the PCB 400 by attaching the pre-formed laminate component to the remaining layers of the PCB 400 (e.g., the first or second insulating layers 125, 125a).

In some embodiments, the strain resistant layers 450, 450a comprise suitable commercially available materials, such as, for example, Kapton® polyimide film, available from E.I. du Pont de Nemours and Company (DuPont). In some embodiments, the adhesive film layer 430 comprises a combination of a thermoset resin and a polyether resin, for example, Epsilon® 9100 Resin, available from Henkel, and Scotch-Weld™ Epoxy Adhesive, available from 3M. In certain embodiments, the PCB 400 comprises pre-formed layers of the first adhesive film layer engaging the first strain resistant layer 450 engaging the first surface conductive layer 120 and/or the second adhesive film layer engaging the second strain resistant layer 450a engaging the second surface conductive layer 450b. In some embodiments, the PCB 400 comprises commercially available pre-formed components of conductive and strain resistant layers such as, for example, R/Flex 1000® available from Rogers Corporation and Pyralux® LF, Pyralux® AC, Pyralux® FR, available from DuPont, and the like.

In FIG. 4, the PCB 400 comprises the adhesive film layers 425, 425a, the strain resistant layers 450, 450a, the surface conductive layers 120, 120a, the insulating layers 125, 125a, the conductive inner layers 130, 130a, 130b, and the insulating inner layers 135, 135a. However, the PCB 400 may comprise more or fewer layers of materials or structures, for example materials or structures not illustrated in FIG. 4. In some embodiments, the strain resistant layers 450, 450a are configured to engage the first and second surface conductive layers 120, 120a, respectively, with other layers of the PCB 400, such as, for example, the insulating layers 125, 125a, respectively. The PCB 400 may comprise additional layers not shown in FIG. 4 such as cover coats to protect the PCB 400 against corrosion and contamination, other materials that for example bond various layers of the PCB 400, and the like. In certain embodiments, a solder resist layer can be over the top surface of one or both of the outermost surface conductive layers 120, 120a. In some embodiments, the PCB 400 can comprise a through-hole penetrating one or more of the layers of the PCB 400. In certain embodiments, the PCB 400 comprises one or more via holes plated with conductive material. Other various configurations are also possible. In some embodiments, the PCB 400 is a single sided and single layer PCB. In some embodiments, the PCB 400 is a double sided and single layer PCB In an embodiment, the PCB 400 comprises at least one rigid insulating layer extending throughout the entire length of the PCB 400 such that the PCB 400 comprises entirely rigid portions.

Still with reference to FIG. 4, the surface conductive layers 120, 120a can be manufactured using one or more suitable processes. In certain embodiments, the surface conductive layers 120, 120a comprise electrodeposited copper made by, for example, plating copper from a copper anode to a cathode. In some embodiments, the PCB 400 comprises surface conductive layers 120, 120a comprising rolled-annealed copper foil. Rolled-annealed copper foil may be made, for example, by heating copper ingots and rolling and annealing the ingots by passing the ingots through a serious of rollers. Certain non-rigid PCBs can comprise surface conductive layers made of rolled-annealed copper because rolled-annealed copper comprises qualities such as ductility (ability to stretch without breaking given as a ratio of length of stretched portion and original length) make rolled-annealed copper suitable for non-rigid purposes such as, for example, flexibility. In some embodiments, ductility of rolled-annealed copper is about 20-45%, including 25%, 30%, 35%, and 40%. Rolled-annealed copper has not been used with rigid PCBs for several reasons, including higher production costs (e.g., compared with electrodeposited copper), lack of availability of various thicknesses and widths, and the perceived lack of benefit of the flexibility of rolled-annealed copper when used in connection with rigid PCBs comprising non-bending portions. Certain qualities exhibited by rolled-annealed copper, such as ductility, hardness, resistance, etc. can make rolled-annealed copper suitable for rigid PCBs (e.g., may minimize defects from forming in the rigid PCB during lead-free manufacturing). For example, the PCB 400 comprising the surface conductive layer 120 comprising rolled-annealed copper can absorb some thermal stress as elastic deformation, thereby likely reducing defects such as pad cratering from occurring, for example, in portions of the cap layer underneath the surface conductive layer 120. In other embodiments, the ability of the PCB 400 to absorb thermal stress may be increased by using the surface conductive layers 120, 120a comprising rolled-annealed copper in combination with the strain resistant layers 450, 450a and adhesive film layers 425, 425a comprising thermal characteristics (e.g., ductility) as further described herein. The surface conductive layers 120, 120a can be manufactured using one or more the above processes, other processes, and combinations thereof.

With continued reference to FIG. 4, the surface conductive layers 120, 120a and the strain resistant layers 450, 450a can be manufactured using one or more suitable processes or methods. In some embodiments, a method of manufacturing the PCB 400 comprises attaching the surface conductive layer 120 to the strain resistant layer 450 using an intermediate layer such as, for example, an adhesive intermediate layer.

In some embodiments, a method of manufacturing the PCB 400 comprises adhesivelessly attaching the surface conductive layers 120, 120a to the strain resistant layers 450, 450a, respectively. The surface conductive layers 120, 120a can be adhesivelessly attached to the strain resistant layers 450, 450a, respectively, using one or more suitable methods. The surface conductive layers 120, 120a and the strain resistant layers 450, 450a can be adhesivelessly attached using a “cast to foil” process wherein a solution of strain resistant material, such as, for example, polyimide, is applied to the conductive layers 120, 120a and heated, resulting the strain resistant layer 450, 450a over the surface conductive layers 120, 120a, respectively. In one embodiment, the PCB 400 comprises polyimide (e.g., the strain resistant layer 450) cast-on-copper (e.g., the surface conductive layer 120). The surface conductive layers 120, 120a and the strain resistant layers 450, 450a can also be adhesivelessly attached using a “sputtering” process wherein conductive cathode (e.g., copper) is bombarded with ions to cause conductive particles impinge on each of the strain resistant layers 450, 450a such that the surface conductive layers 120, 120a are over the strain resistant layers 450, 450a, respectively. In certain embodiments, a method of manufacturing the PCB 400 comprises plating (e.g., electroless plating) conductive material on each of the strain resistant layers 450, 450a to form the surface conductive layers 120, 120a adhesivelessly engaging the strain resistant layers 450, 450a, respectively. In some embodiments, a “vapor deposition” method of making the PCB 400 comprises vaporizing conductive material such as copper in a vacuum chamber and depositing the metal vapor on strain resistant material, thereby forming the strain resistant layers 450, 450a adhesivelessly engaging the surface conductive layers 120, 120a, respectively. Further still, a method of making the PCB 400 can comprise further treating the surface conductive layers 120, 120a engaging the strain resistant layers 450, 450a, either adhesivelessly or using an intermediate bonding layer such as an adhesive, with other processes such as, for example, bonding, stabilizing, etc.

Although FIG. 4 illustrates the strain resistant layers 450, 450a positioned as cap layers and engaging the surface conductive layers 120, 120a, respectively, the strain resistant layers 450, 450a can be suitably used with the PCB 400 in other configurations. For example, although FIG. 4 shows the strain resistant layer 450 between the surface conductive layer 120 and the adhesive film layer 425, the strain resistant layer 450 can be the only dielectric between the surface conductive layer 120 and the first electrically conductive inner layer 130. In some embodiments, additional strain resistant materials comprising, for example, polyester, liquid crystal polymer, polyimide, etc. can also be suitably used as binding material in the central, normally rigid, glass layer/prepreg portions of PCBs. In still some embodiments, one or more of the strain resistant layers may be formed (e.g., deposited) elsewhere in the PCB 400. In one embodiment, strain resistant layers can be between and/or engage inner conductive layers, for example, the conductive inner layer 130a, and inner insulating layers, such as, for example, the insulating inner layer 135a. In some embodiments, the strain resistant layers 450, 450a are configured to respectively engage the first and second surface conductive layers 120, 120a with other layers of the PCB 400, such as, for example, the conductive inner layers 130, 130a.

With continued reference to FIG. 4, the strain resistant layers 450, 450a in certain embodiments comprise at least substantially fiberglass-free material. The strain resistant layers 450, 450a comprising fiberglass-free material can help to reduce (e.g., minimize, eliminate) the occurrence of electrical failure arising from cathodic/anodic filament (CAF) growth. CAF growth can result in an electrical shorting failure when dendritic metal filaments grow along insulating interfaces (typically layers comprising glass fiber/epoxy resin interface), such as, for example, the insulating inner layers 135, 135a and/or the insulating layers 125, 125a, creating an electrical path between two or more layers of the PCB 400 that should remain electrically isolated (for example, portions of the surface conductive layer 120 and portions of the conductive inner layer 130 or portions of the conductive inner layer 130 and portions of the conductive inner layer 130a). Strain resistant layers in accordance with embodiments disclosed herein can reduce (e.g., minimize, eliminate) CAF growth because, as previously mentioned, the strain resistant layers (for example, the strain resistant layers 450, 450a) do not comprise or are substantially free of fiberglass material that might otherwise provide the surface along which the dendritic metal filaments may grow. In certain embodiments, one or more strain resistant layers can be used instead of one or more rigid insulating layers of PCBs, including rigid PCBs (e.g., instead of one or more of the insulating inner layers 135, 135a and/or the insulating layers 125, 125a).

With continued reference to FIG. 4, the adhesive film layers 425, 425a in certain embodiments comprise at least substantially fiberglass-free and Bisphenol A-free material. The adhesive film layers 425, 425a comprising fiberglass-free material can help to reduce (e.g., minimize, eliminate) the occurrence of electrical failure arising from cathodic/anodic filament (CAF) growth. As noted above, CAF growth can result in an electrical shorting failure when dendritic metal filaments grow along insulating interfaces (typically layers comprising glass fiber/epoxy resin interface), such as, for example, the insulating inner layers 135, 135a and/or the insulating layers 125, 125a, creating an electrical path between two or more layers of the PCB 400 that should remain electrically isolated (for example, portions of the surface conductive layer 120 and portions of the conductive inner layer 130 or portions of the conductive inner layer 130 and portions of the conductive inner layer 130a). Adhesive film layers in accordance with embodiments disclosed herein can reduce (e.g., minimize, eliminate) CAF growth because, as previously mentioned, the adhesive film layers (for example, the adhesive film layers 425, 425a) do not comprise or are substantially free of fiberglass material that might otherwise provide the surface along which the dendritic metal filaments may grow. In certain embodiments, one or more adhesive film layers can be used instead of one or more rigid insulating layers of PCBs, including rigid PCBs (e.g., instead of one or more of the insulating inner layers 135, 135a and/or the insulating layers 125, 125a).

In accordance to certain embodiments, each of the strain resistant layers 450, 450a can have a thickness in the range of about 10-30 microns, including about 10-15 microns, 12-15 microns, 15-17 microns, 15-20 microns, 15-25 microns, and 20-30 microns. In certain embodiments, each of the strain resistant layers 450, 450a can have a thickness of about 12 microns, including about 15 microns, 17 microns, 18 microns, 20 microns, 22 microns, 25 microns, and 28 microns. The strain resistant layers 450, 450a can comprise thicknesses in the range of about 5-100 microns, including about 10-20 microns, 20-30 microns, 30-40 microns, 40-50 microns, 50-60 microns, 60-70 microns, 70-80 microns, 80-90 microns, 90-100 microns, 100-120 microns, 110-130 microns, and the like. In certain embodiments, each of the strain resistant layers 450, 450a can have a thickness of about 35 microns, including about 45 microns, 55 microns, 65 microns, 75 microns, 85 microns, 95 microns, 105 microns, and the like. In one embodiment, each of the strain resistant layers 450, 450a have thicknesses of less than 10 microns (e.g., 8 microns), thicknesses of greater than 30 microns (e.g., about 32 microns), or both. In one embodiment, each of the strain resistant layers 450, 450a have thicknesses of less than 5 microns (e.g., 1 micron), thicknesses of greater than 130 microns (e.g., about 150 microns), or both. In accordance to certain embodiments, each of the surface conductive layers 120, 120a can have a thickness in the range of about 15-25 microns, including about 15-17 microns, 16-18 microns, 17-19 microns, 16-19 microns, and 18-20 microns. The surface conductive layers 120, 120a can comprise thicknesses in the range of about 5-100 microns, including about 10-20 microns, 20-30 microns, 30-40 microns, 40-50 microns, 50-60 microns, 60-70 microns, 70-80 microns, 80-90 microns, 90-100 microns, 100-120 microns, 110-130 microns, and the like. In certain embodiments, each of the surface conductive layers 120, 120a can have a thickness of about 35 microns, including about 45 microns, 55 microns, 65 microns, 75 microns, 85 microns, 95 microns, 105 microns, and the like. In accordance to various embodiments, each of the surface conductive layers 120, 120a can have a thickness of about 16 microns, including 17 microns, 18 microns, 19 microns, 20 microns, 25 microns, 26 microns, etc. In an embodiment, each of the surface conductive layers 120, 120a can have thicknesses of less than about 15 microns (e.g., about 14 microns), a thicknesses of greater than about 25 microns (e.g., 27 microns), or both. In one embodiment, each of the surface conductive layers 120, 120a can have thicknesses of less than about 5 microns (e.g., about 1 micron), a thicknesses of greater than about 130 microns (e.g., about 150 microns), or both. In an embodiment, the strain resistant layers 450, 450a can be about 0.0005 inches thick. In accordance to certain embodiments, each of the adhesive film layers 425, 425a can have a thickness in the range of about 10-30 microns, including about 10-15 microns, 12-15 microns, 15-17 microns, 15-20 microns, 15-25 microns, and 20-30 microns. In certain embodiments, each of the adhesive film layers 425, 425a can have a thickness of about 12 microns, including about 15 microns, 17 microns, 18 microns, 20 microns, 22 microns, 25 microns, and 28 microns. The adhesive film layers 425, 425a can comprise thicknesses in the range of about 5-100 microns, including about 10-20 microns, 20-30 microns, 30-40 microns, 40-50 microns, 50-60 microns, 60-70 microns, 70-80 microns, 80-90 microns, 90-100 microns, 100-120 microns, 110-130 microns, and the like. In certain embodiments, each of the adhesive film layers 425, 425a can have a thickness of about 35 microns, including about 45 microns, 55 microns, 65 microns, 75 microns, 85 microns, 95 microns, 105 microns, and the like. In one embodiment, each of the adhesive film layers 425, 425a have thicknesses of less than 10 microns (e.g., 8 microns), thicknesses of greater than 30 microns (e.g., about 32 microns), or both. In one embodiment, each of the adhesive film layers 425, 425a have thicknesses of less than 5 microns (e.g., 1 micron), thicknesses of greater than 130 microns (e.g., about 150 microns), or both.

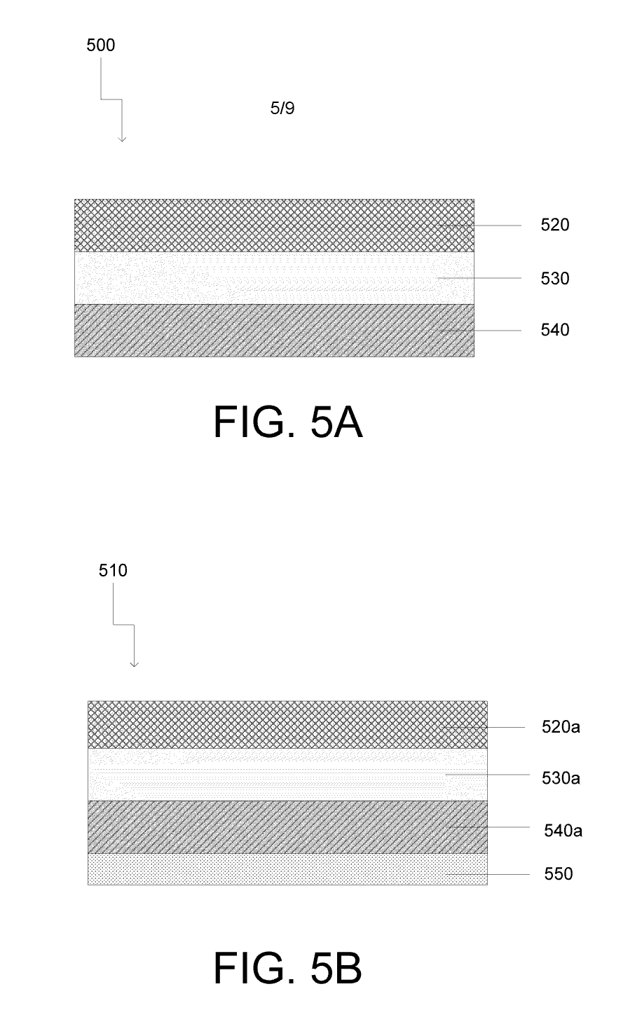

FIG. 5A illustrates a preformed multilayer component 500 that can be used in the manufacture of a PCB comprising a conductive layer 520, a strain resistant layer 530, and an adhesive film layer 540. The surface conductive layer 520 is over the strain resistant layer 530, the latter of which is over the adhesive film layer 540. The top surface of the strain resistant layer 530 engages the first surface conductive layer 520 and the bottom surface of the strain resistant layer 5300 engages the adhesive film layer 540. In some embodiments, a pre-formed laminate component comprises the strain resistant layer 530 engaging the first surface conductive layer 410 which engages the adhesive film layer 540.

FIG. 5B illustrates a preformed multilayer component 510 that can be used to in the manufacture of a PCB comprising a conductive layer 520a, a strain resistant layer 530a, an adhesive film layer 540a, and a discardable protective layer 550. The surface conductive layer 520a is over the strain resistant layer 530a, the latter of which is over the adhesive film layer 540a which in turn, is over the discardable protective layer 550. The top surface of the strain resistant layer 530a engages the first surface conductive layer 520a and the bottom surface of the strain resistant layer 530a engages the top surface of the adhesive film layer 540a. The bottom surface of the adhesive film layer 540a engages the top surface of the discardable protective layer 550. In some embodiments, a pre-formed laminate component comprises the strain resistant layer 530a engaging the first surface conductive layer 520a which engages the adhesive film layer 540a which engages the discardable protective layer 550.

In some embodiments, the strain resistant layer 530a comprises suitable commercially available materials, such as, for example, Kapton® polyimide film, available from E.I. du Pont de Nemours and Company (DuPont). In some embodiments, the adhesive film layer 540a comprises a combination of thermoset resin and polyether resin, for example, a benzoxazine resin and a phenoxy resin, such as Epsilon® 9100 Resin, available from Henkel and Scotch-Weld™ Epoxy Adhesive, available from 3M. In some embodiments, the discardable protective layer 550 comprises polyethylene terephthalate, commercially available as Mylar® from DuPont Teijin. In certain embodiments, the component 510 comprises pre-formed layers of the first strain resistant layer 530a engaging both the first surface conductive layer 520a and the first surface adhesive film layer 540a, wherein the second surface of the adhesive film layer 540a engages the discardable protective layer 550. In some embodiments, the component 510 comprises commercially available pre-formed components of conductive and strain resistant layers such as, for example, R/Flex 1000® available from Rogers Corporation and Pyralux® LF, Pyralux® AC, Pyralux® FR, available from DuPont, and the like. In other embodiments, the adhesive film layer 540a is comprised of a mixture of a benzoxazine resin and a phenoxy resin, as described in greater detail below.

In accordance with various embodiments disclosed herein, a number of processes and methods can be used to manufacture rigid PCBs (or rigid portions of partially rigid PCBs) and assemblies comprising semiconductor and/or circuit components. In some embodiments, a methods of manufacturing a rigid printed circuit board assembly comprises providing a first component comprising a conductive layer, a strain resistant layer, and an adhesive film layer, providing a stack of laminates comprising at least one insulating layer, and attaching the first component to the stack of laminates, thereby at least partially (e.g., fully) forming a printed circuit board. In one embodiment, the stack of laminates comprises at last one rigid insulating layer. The conductive layer of the first component can be a surface conductive layer and/or the strain resistant layer of the first component can be a cap layer. In certain embodiments, the method of manufacturing PCBs further comprises mounting or attaching a circuit component on the printed circuit board to thereby form a rigid printed circuit board assembly. In certain embodiments, the conductive layer of the first component comprises rolled-annealed copper and/or the strain resistant layer of the first component comprises polyimide.

In some configurations, providing a stack of laminates comprises providing at least one insulating layer comprising a rigid material. In certain embodiments, providing a stack of laminates comprises forming one or more internal conductive layers engaging the one or more insulating layers. In some embodiments, providing the stack of laminates further comprises etching the one or more internal conductive layers, thereby forming circuit patterns. In some arrangements, attaching the first component to the stack of laminates comprises connecting the adhesive film layer of the first component with the stack of laminates. With reference to FIG. 5a, in one embodiment, a strain resistant layer (e.g., the strain resistant layer 530) comprises a first surface and a second surface, wherein the first surface is substantially opposite from the second surface (e.g., the top surface of the strain resistant layer 530 engaging the bottom surface of the surface copper layer 520 is substantially opposite from the bottom surface of the strain resistant layer 530 engaging the top surface of the adhesive film layer 540). In some arrangements, attaching the first component to the stack of laminates comprises attaching the bottom surface of the adhesive film layer to the top surface of the stack. In some configurations, mounting the circuit component onto the rigid printed circuit board to form a rigid printed circuit board assembly comprises connecting the circuit component to the conductive layer of the first component using soldering material.

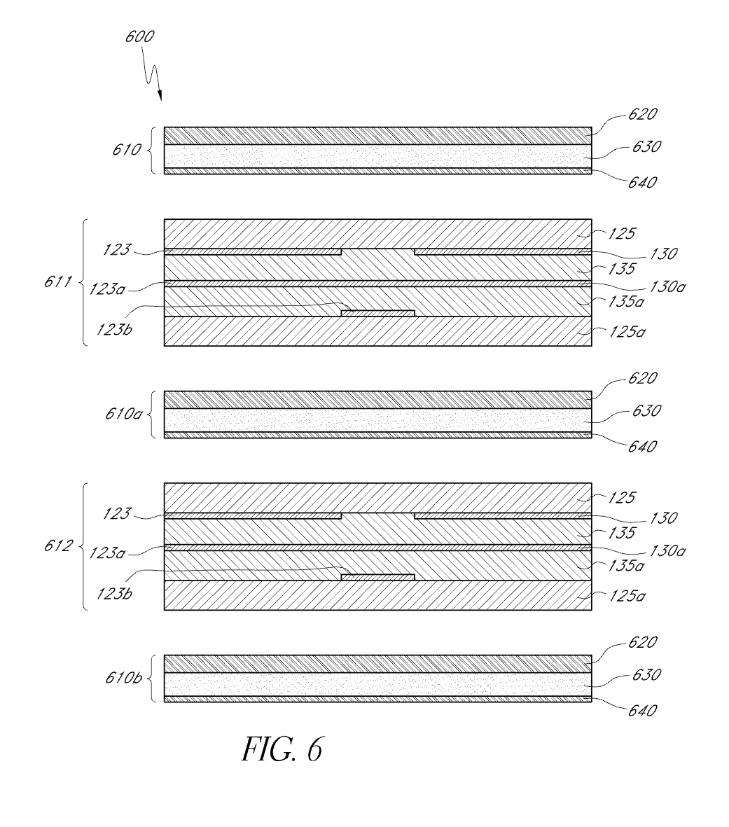

FIG. 6 illustrates an embodiment of components for manufacturing PCBs, including rigid and partially rigid PCBs, some portions of which may be disclosed in U.S. Pat. No. 5,674,596, the entire content of which is expressly incorporated herein by reference. A stack 600 of laminates for use with rigid PCBs comprises three components 610, 610a, 610b, each comprising a discardable separator layer 630, and two PCB laminated layers 611, 612. For illustrative purposes only, the PCB laminated layers 611, 612 are illustrated similarly to the PCB 100 of FIG. 1 (e.g., each comprising insulating outer layers 125, 125a, inner conductive layers 130, 130a, and inner insulating layers 135, 135a) but without the surface conductive layers 120, 120a of FIG. 1. The components 610, 610a, 610b each can comprise a discardable layer 630 comprising discardable materials such as metals (e.g., aluminum) between two conductive layers 620, 640. The conductive layers 620, 640 can comprise material different from the discardable layer 630 (e.g., comprising copper when the discardable layer 630 comprises aluminum). The surfaces of the conductive layers 620, 640 facing the discardable layer 630 can be processed to be substantially free of particles or defects, and are protected from exposure to various contaminants, such as, for example, airborne particles and resin dust, by the discardable layer 630. Although the stack 600 shows the three components 610, 610a, 610b and the two PCB laminated layers 611, 612, the configuration is for illustrative purposes only and the stack 600 can comprise more or fewer numbers of components and/or PCB laminate layers.

In an embodiment of manufacturing one or more PCBs, including rigid PCBs, a method comprises releasing the conductive layers 620, 640 from the discardable layer 630 and to form the outer conductive layers of PCBs as described herein. For example, the method can comprise attaching the conductive layers 620, 640 of the component 610a as surface conductive layers to the insulating outer layer 125a of the PCB laminate layer 611 and the insulating outer layer 125 of the PCB laminate layer 612, respectively. An embodiment of the method can comprise at least partially separating one or both of the conductive layers 620, 640 of the component 610a from the discardable layer 630 of the component 610a. The conductive layer 640 of the component 610 can attach as a surface conductive layer to the insulating outer layer 125 of the PCB laminate layer 611. The conductive layer 640 of the component 610 can then at least partially separate from the discardable layer 630 of the component 610. In certain such embodiments, the method can also comprise attaching the conductive layer 620 of the component 610 as a surface conductive layer to the insulating outer layer of another PCB laminate layer (not shown above the component 610), and the conductive layer 620 of the component 610 can then at least partially separate from the discardable layer 630 of the component 610. The conductive layer 620 of the component 610b can attach as a surface conductive layer to the insulating layer 125a of the PCB laminate layer 612. The conductive layer 620 can then at least partially separate from the discardable layer 630 of the component 610b. In certain such embodiments, the method can comprise attaching the conductive layer 640 as a surface conductive layer to the insulating outer layer of another PCB laminate layer (not shown below the component 610b), and then at least partially separating the conductive layer 640 of the component 610b from the discardable layer 630 of the component 610b. After separation from the conductive layers 620, 640 of the components 610, 610a, 610b, the method can comprise discarding the discardable layers 630 of the components 610, 610a, 610b (e.g., by selective etching of the material of the discardable layers 630). In certain embodiments, the conductive layers of the components comprising discardable layer (e.g., the conductive layer 620 of the component 610a comprising the discardable layer 630) are first released from the components by, for example, at least partially separating the conductive layers from the discardable layer, and then attached to the conductive layers as surface conductive layers of PCB laminates (e.g., to the insulating layer 125a of PCB laminate 611).

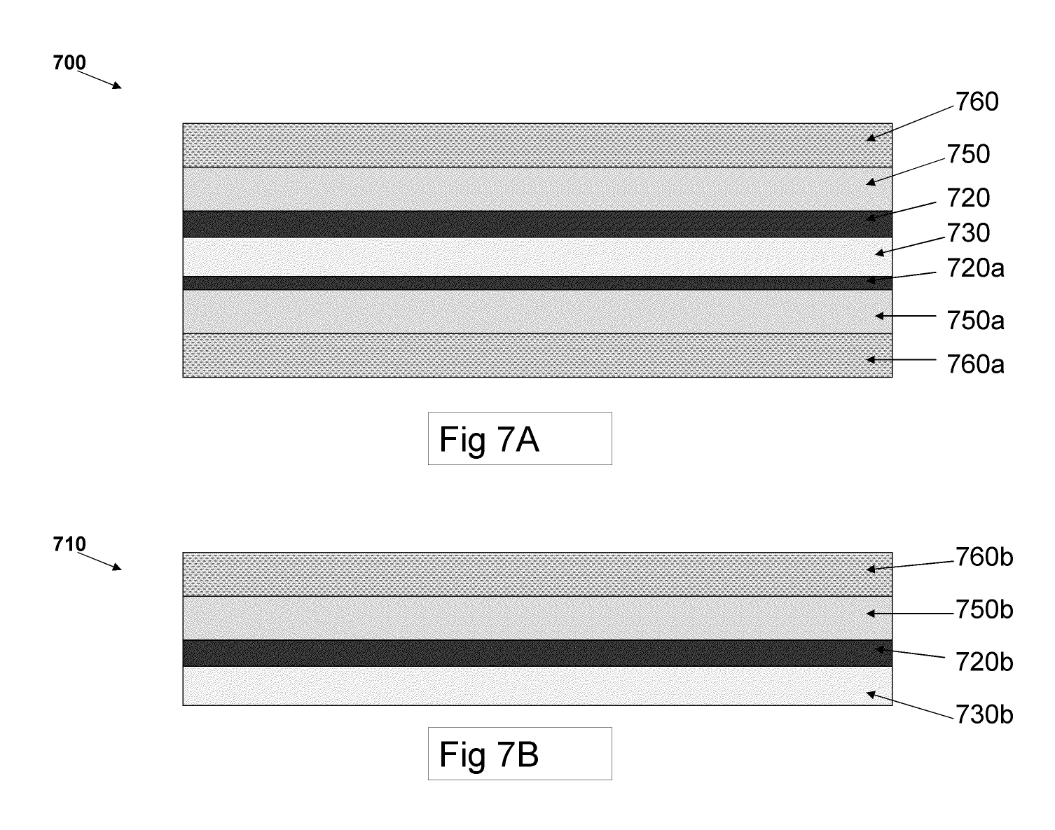

FIG. 7A shows a component 700 for manufacturing PCBs comprising two conductive layers 720, 720a and a discardable layer 730 comprising discardable materials, including metals, such as, for example, aluminum. The two conductive layers 720, 720a (e.g., each comprising copper) are over opposite sides of the discardable layer 730. The component 700 further comprises stress resistant layers 750, 750a over the outer surfaces of the conductive layers 720, 720a. The component 700 further comprises adhesive film layers 760, 760a over the outer surfaces of the stress resistant layers 750, 750a. Returning back to FIG. 6, the component 700 of FIG. 7A can be used instead of one or more of the components 610, 610a, 610b, thereby attaching the adhesive film layers 760, 760a, strain resistant layers 750, 750a, as well as the conductive layers 720, 720a, onto one or more of the PCB laminate layers 611, 612 and/or other PCB laminate layers (not shown). For example, when using the component 700 in place of the component 610a, the method of manufacturing PCBs can comprise attaching the adhesive film layers 760, 760a to the insulating outer layer 125a of the PCB laminate layer 611 and the insulating outer layer 125 of the PCB laminate layer 612, respectively. The conductive layers 720, 720a of the component 700, which still are attached to the strain resistant layers 750, 750a, respectively, also attach to the PCB laminate layers 611, 612, respectively, as surface conductive layers. In certain embodiments, the method can comprise at least partially separating one or both of the conductive layers 720, 720a of the component 700 from the discardable layer 730 of the component 700. In an embodiment, the discardable layer 730 of the component 700 can be discarded (e.g., by selective etching of the material of the discardable layer 730). In a further embodiment, the discardable layer 730 is discarded after one or both of the conductive layers 720, 720a at least partially separate from the discardable layer 730. In this manner, the conductive layers 720, 720a, the strain resistant layers 750, 750a, and the adhesive film layers 760, 760a can be effectively attached to PCB laminates 611, 622, respectively. In some embodiments, the component 700 comprises pre-formed layers of the first conductive layer 720 engaging the strain resistant outer layers 750 engaging the adhesive outer layers 760, the second conductive layer 720a engaging the second stress resistant outer layers 750a engaging the second adhesive film layers 760a or both. In other embodiments, the pre-formed layers comprise laminated products, such as, for example, DuPont's Pyralux® FR, Pyralux® LF, etc.

FIG. 7B shows an embodiment of another component 710 for use with manufacturing PCBs, including rigid PCBs. The component 710 comprises a discardable separator 730b, a conductive layer 720b, a strain resistant layer 750b, and an adhesive film layer 760b. The conductive layer 720b is over the discardable layer 730b and engages the discardable layer 730b. The strain resistant layer 750b is over the conductive layer 720b and engages the conductive layer 720b. The adhesive film layer 760b is over the strain resistant layer 750b and engages the strain resistant layer 750b. Returning back to FIG. 6, the component 710 can be used to provide the adhesive film layer 760b, the strain resistant layer 750b, and the conductive layer 720b over the outermost PCB laminates 611, 612 of the stack 600. For example, if the PCB laminate layer 612 is the outermost PCB laminate layer on the bottom of the stack 600, using double-sided components such as the component 700 could cause at least one of the conductive layers 720, 720a of the component 700, at least one of the strain resistant layers 750, 750a, and at least one of the adhesive film layers 760, 760b of the component 700 to be discarded without attaching to anything. The component 710 of FIG. 7B can advantageously be used on outer PCB laminates of the stack 600 instead of the component 700, thereby eliminating the unnecessary discarding of conductive layers, adhesive film layers, and/or strain resistant layers. The adhesive film layer 760b, the strain resistant layer 750b, as well as the conductive layer 720b, of the component 710 can attach to the insulating layer 125a of the outer most PCB laminate layer, (e.g., the PCB layer 612). The conductive layer 720b can then at least partially separate from the discardable layer 730b of the component 710. The discardable layer 730b of the component 710, for example after at least partial separation from the conductive layer 720b of the component 710, can be discarded (e.g., by selective etching of the material of the discardable layer 730).

In certain preferred embodiments of the components disclosed in FIGS. 6, 7A, and 7B, the conductive layers 620, 640, 750a, 750b comprise copper and/or the discardable layers 630, 730 comprise aluminum. However, the conductive layers 620, 640, 750a, 750b and/or the discardable layers 630, 730 can comprise any suitable metals, including, without limitation, gold, nickel, copper, aluminum, nickel, kovar, steel, and alloys and combinations thereof, without departing from the embodiments disclosed in the present application.

According to an embodiment, the adhesive film as described herein is coated on a polyester resin to form a two layer system. In one method of manufacturing, an adhesive layer is coated on the polyester resin. In some embodiments, a method of manufacturing may comprise coating more than one adhesive layer on the polyester resin to form a multiple layer system. In a two-layer system may comprise a layer of adhesive attached to a polyester resin layer. In other embodiments, two or more adhesive layers are attached to the polyester resin layer. The polyester resin may be any suitable polyester resin such as a polyethylene terephthalate film such as Mylar®. The polyester resin functions as a carrier for the adhesive film layer and may be easily peeled off of the polyester film layer. In such an embodiment, the thickness of the adhesive film layer may be between about 12 microns and about 100 microns. According to some embodiments the thickness of the adhesive film layer may be about 25 microns to 100 microns, about 25 microns to 50 microns, about 50 microns to 75 microns, about 75 microns to about 100 microns, and the like. An adhesive film layer coated directly on polyester system may exhibit beneficial properties such as increased flexibility and reduced cost.

According to an embodiment, an adhesive film layer as described herein may be coated directly on copper foil or a conductive carrier. This can form a two layer system. A two layer system may comprise an adhesive film layer attached to a copper foil layer or a conductive layer. In one method of manufacturing, an adhesive layer is coated on the copper foil or conductive carrier. In some embodiments, a method of manufacturing may comprise coating more than one adhesive layer on the copper foil or conductive carrier to form a multiple layer system. In some embodiments, multiple layers of adhesive may be coated on copper foil to form a multiple layer system. In yet other embodiments, layers of copper foil and adhesive film layer can be coated alternatively to form a multiple layer system. In such an embodiment, a multiple layer system may comprise an adhesive layer may be attached to a second adhesive layer, which then may be attached to a copper foil or conductive layer. An adhesive film layer coated directly on copper foil system may exhibit beneficial properties such as increased flexibility and reduced cost.

### C. Materials used for Adhesive Film Layer and Advantageous Material Characteristics

Material characteristics and other properties of the adhesive film layers described herein will now be discussed. The adhesive film layers preferably have mechanical and thermal characteristics that resist, for example, damage caused by stress, including, without limitation, thermal and mechanical strain. In certain embodiments, the strain adhesive film layers comprise more stable material (e.g., thermally, physically, mechanically, etc.) than rigid insulating layers as described herein. In some embodiments, the adhesive film layers can be more dimensionally stable, for example, under high temperatures, than rigid insulating layers. In some embodiments, the adhesive film layers comprise a material suitable for manufacturing PCBs comprising non-rigid bendable portions, such as, for example, benzoxazine, polyether, phenoxy thereof, and the like. In some embodiments, the adhesive film layers can be manufactured from a mixture of the above-mentioned or other materials.

In certain preferred embodiments, the adhesive film layers comprise thermoset resins such as a combination of benzoxazine resin and phenoxy resin. Additionally, the film can be substantially halogen free, non-glass reinforced, substantially lead free, substantially Bisphenol A free, and substantially fiberglass free. The adhesive film layers can be substantially free of lead. In one embodiment, the adhesive film layers are substantially free of halogen. In another, the adhesive film layers are substantially free of fiberglass. The adhesive film layers can be substantially free of Bisphenol A. In some embodiments, the adhesive film layers comprise partially, substantially, or fully cured or uncured benzoxazine and phenoxy resins. In some embodiments, the adhesive film layers do not require a bonding treatment, oxidation or other special treatments for adhesion. In some embodiments, the adhesive film layers' viscosity drops upon heating to flow and fill complex circuits and micro vias and provide leveling of the PCB.

The adhesive film layers in accordance with embodiments disclosed herein are composed of a thermoset resin and an epoxy resin. For example, the thermoset resin is benzoxazine resin and the epoxy resin is phenoxy resin, present in a ratio of 85 wt % benzoxazine and 15 wt % phenoxy. In other embodiments, the composition comprises about 65-90 wt % benzoxazine and also about 70 wt %, 75 wt %, 80 wt %, and 85 wt % benzoxazine. In certain embodiments, the adhesive film layer comprises benzoxazine in the range of about 65-70 wt %, 70-80 wt %, 80-90 wt %, 70-90 wt %, and the like. Further still, the adhesive film layers can comprise benzoxazine different from the ranges provided herein, and can comprise benzoxazine less than about 65 wt % (e.g., about 50 wt %), greater than about 90 wt % (e.g., about 95 wt %). In some embodiments, the adhesive film layers comprise benzoxazine of at least about 65 wt %. The composition of an embodiment may be comprised of about 10-35 wt % phenoxy resin and also be about 15 wt %, 20 wt %, 25 wt %, 30 wt % and 35 wt % phenoxy resin. In certain embodiments, the adhesive film layer comprises phenoxy resin in the range of about 10-15 wt %, 15-20 wt %, 20-25 wt %, 25-30 wt %, 30-35 wt % and the like. Further still, the adhesive film layers can comprise phenoxy different from the ranges provided herein, and can comprise phenoxy less than about 10 wt % (e.g., about 5 wt % or about 0 wt %), greater than about 35 wt % (e.g., about 40 wt %). In some embodiments, the adhesive film layers comprise phenoxy of at least about 25 wt %.

To manufacture the adhesive film layer, in one embodiment the thermoset resin is first heated above its melting temperature. A solvent, for example methyl ethyl ketone (MEK) is added, and then the polyether resin is added to the liquid thermoset resin. The mixture is heated and blended until homogenous, and then formed into a film. The film is preferably coated onto a carrier such as Mylar, and formed in sheets of 12 inch, 19 inch, or other suitable widths. The film is then dried to remove the solvent. Alternatively, the thermoset and polyether resins can first be mixed together, then heated above the melting temperature and blended until homogenous, or the polyether resin can be first heated above its melting temperature, the thermoset resin added, and the mixture heated and blended until homogenous.

The adhesive film layers in accordance with embodiments disclosed herein provide several advantages when used in connection with rigid PCBs. The adhesive film layers and materials described herein have not been previously used in the manufacture of rigid PCBs for several reasons, including higher production costs, lack of availability of various thicknesses and widths, the perceived lack of benefit of characteristics of these materials when used in connection with rigid PCBs comprising non-bending portions, and the like. Certain qualities exhibited by the adhesive film layer described herein make the layers suitable for use in rigid PCBs as further described herein.

In accordance with various embodiments disclosed herein, adhesive film layers comprising resins such as, without limitation, benzoxazine and phenoxy based materials can be configured to reduce (e.g., minimize, eliminate), among other defects, pad cratering. The adhesive film layers comprising benzoxazine and phenoxy can be advantageously more ductile than other known adhesives. The ductility (sometimes also referred to as elongation) of the adhesive film layer comprising benzoxazine and phenoxy, can be in the range of about 15-80%, and also can be about 20%, 25%, 30%, 40%, 45%, 50%, 60%, 65%, 70%, and 75%. In certain embodiments, the adhesive film layer comprises ductility in the range of about 15-20%, 20-30%, 30-40%, 20-60%, 40-80%, 50-80%, 15-35%, and the like. Further still, the adhesive film layers can comprise ductility different from the ranges provided herein, and can comprise ductility less than about 15% (e.g., about 10%), greater than about 80% (e.g., about 90%). In some embodiments, the adhesive film layers comprise ductility of at least about 15%.

The adhesive film layers described herein have higher ductility properties than other known adhesive materials. As previously mentioned, thermal stress resulting from changes in temperature can cause unequal responses (e.g., rates of expansion, contraction, etc.) in insulating and non-insulating layers, including cap layers, of PCBs and other materials (e.g., surface conductive layers, soldering materials, electrical component conductive pads, etc.). In some situations, thermal stress can cause the surface conductive layers of PCBs and cap layers underneath the surface conductive layers to move relative to each other (e.g., in opposite directions, in other directions placing strain on the connection between the cap layers and the surface copper layers, etc.) such that defects such as pad cratering form in or around, among others, the cap layers. The adhesive film layers comprised of a combination of benzoxazine and phenoxy resins disclosed herein are more ductile than other known adhesives, and can reduce (e.g., minimize, eliminate) pad cratering by, for example, at least absorbing some of the thermal stress as elastic deformation. The adhesive film layers comprising ductile material as disclosed herein can also absorb mechanical stress exerted onto components of PCBs (e.g., cap layers), for example, by other more rigid PCB components such as lead-free soldering material, further reducing the occurring of defects such as pad cratering in the PCB components including in the cap layers.

The various disclosed PCB embodiments can suitably comprise adhesive film layers having different mixtures of benzoxazine and phenoxy. In some embodiments, adhesive film layers comprising a different mix of benzoxazine, phenoxy and/or other materials may have elongation and other properties that are different from those mentioned.

In accordance with certain embodiments disclosed herein, adhesive film layers (e.g., comprising benzoxazine and phenoxy) can have favorable properties that may reduce (e.g., minimize, eliminate) failures caused by, among others, pad cratering. In particular adhesive film layers comprising benzoxazine and phenoxy resins can have a Glass Transition Temperature (Tg) range of about 80-300° C., and can also have Tg values of about 100° C., 150° C., 180° C., 210° C., 250° C., and 280° C. In some embodiments, the adhesive film layers have Tg values of about 120° C., including Tg values of about 115° C., 130° C., 135° C., 145° C., 150° C., 155° C., 165° C., 170° C., 185° C., 200° C., 205° C., 215° C., 230° C., 250° C., 260° C., 270° C., 275° C., 285° C., 300° C., and the like. In certain embodiments, the adhesive film layers have Tg values in the range of about 80-300° C., including about 100-150° C., 150-200° C., 200-250° C., 250-300° C., and the like. Further still, the adhesive film layers can have Tg values different from the ranges provided herein, and can comprise Tg less than 80° C. (e.g., 50° C.), greater than 300° C. (e.g., 400° C.), or both. In some embodiments, the strain resistant layers comprise material such as benzoxazine and phenoxy resins having Tg of at least 180° C.

Materials with higher Tg ranges can be advantageous for use as insulating layers, including for use as cap layers in rigid PCBs, because such materials can maintain their dimensional stability (e.g., expand and/or contract less in response to, among others, changes in temperature) over a wider temperature range, potentially reducing the likelihood that cracks will occur in various PCB layers, including cap layers.

The adhesive film layers comprising benzoxazine and phenoxy resins have Coefficients of Thermal Expansion (CTE), including CTE values in the lateral (X and Y) directions (CTE X,Y) configured to, among others, resist defects such as pad cratering that occur in insulating layers, including cap layers. CTE X,Y values for certain such adhesive film layers can be lower than the CTE X,Y values for other adhesive film layers. Materials having lower CTE X,Y characteristics are more stable than materials having higher CTE X,Y characteristics because materials having lower CTE X,Y values generally are less responsive (e.g., expand, contract, etc.) to temperature changes.

In certain embodiments, the adhesive film layer comprising material such as benzoxazine and phenoxy resins has CTE X,Y values in the range of about 50-85 ppm/° C., including about 50-55 ppm/° C., 50-60 ppm/° C., 55-60 ppm/° C., 60-65 ppm/° C., 65-75 ppm/° C., and the like. Further still, the adhesive film layers can have CTE X,Y values different from the ranges provided herein, and can have CTE X,Y less than about 50 ppm/° C. (e.g., about 45 ppm/° C.), greater than about 85 ppm/° C. (e.g., about 90 ppm/° C.), or both. In some embodiments, the adhesive film layers comprise material having CTE X,Y of about 75 ppm/° C. or less. The adhesive materials can also have CTE of about 65 ppm/° C. or less, including about 60 ppm/° C., 63 ppm/° C., 61 ppm/° C., 59 ppm/° C., 58 ppm/° C., 50 ppm/° C., and the like.

According to some embodiments, an adhesive film layer may contain amounts of both uncured and cured benzoxazine resin. For example, a composition may comprise an uncured benzoxazine resin present in an amount in the range of 75% by weight to 95% by weight based on the total weight of the composition and an uncured phenoxy resin present in the composition in an amount in the range of 5% by weight to 25% by weight based on the total weight of the composition. The uncured benzoxazine resin may be present in an amount of about 85% or about 80% based on the total weight of the composition of the adhesive film layer. The composition may also comprise an amount of cured benzoxazine resin. The cured benzoxazine resin may be present in the composition in an amount in the range of 5% by weight to 25% by weight based on the total weight of the composition of the adhesive film layer. The cured benzoxazine resin may also be present in an amount of 5% by weight to 10% by weight, 10% by weight to 20% by weight, 15% by weight to 25% by weight, 20% by weight to 25% by weight, and the like. According to some embodiments, the adhesive layer is substantially all uncured and/or cured benzoxazine resin (95%-100% by weight based on the total weight of the composition of the adhesive layer).

According to other embodiments, the adhesive film layer may also comprise a plasticizer to increase flexibility in the adhesive film layer such one or more of very high molecular weight polyethylene oxide, propylene homopolymer, propylene-ethylene copolymer, or iso-cyanate monomer present in an amount of 0.1 to 25% by weight based on the total weight of the composition of the adhesive layer. The plasticizer may also be present in an amount of 5% by weight to 10% by weight, 10% by weight to 20% by weight, 15% by weight to 25% by weight, 20% by weight to 25% by weight, and the like.

The adhesive film layer may also comprise one or more filler such as talc, fumed silica, silane treated silicon dioxide, aromatic polyimide, fluorocarbon particles or fluorocarbon flakes. The filler may be present in the composition in an amount in the range of 5% to 50% by weight based on the total weight of the composition of the adhesive layer. In other embodiments, the filler may be present in the composition in an amount in the range of 5% by weight to 10% by weight, 10% by weight to 20% by weight, 15% by weight to 25% by weight, 20% by weight to 25% by weight, 30% to 40% by weight, or 40% to 50% by weight.

The filler used should be substantially wettable by the benzoxazine resin in the adhesive layer composition. In some embodiments, the average particle size of the filler is less than or equal to 50 microns, less than or equal to 40 microns, or less than or equal to 30 microns. Preferably, the average particle size of the filler is less than 20 microns.

A filler used in the compositions described herein may be able to modify the expansion properties of the adhesive layer, its dielectric attributes, its flow, flexibility, and toughness.

The adhesive film layer as described herein exhibits several improved and beneficial properties. For example, the adhesive layer is low tack or substantially tack-free. That is, even though the adhesive film layer may comprise a portion of uncured resin, it is not sticky or tacky. By keeping the material tack-free, easier coating of the adhesive layer on a material such as a polyester base is facilitated. The resulting material is an uncured or substantially uncured dry film. The uncured film can be later cured to bond layers together in printed circuit board applications.

### C. Materials used for Strain Resistant Layer and Advantageous Material Characteristics

Material characteristics and other properties of the strain resistant layers disclosed in various embodiments herein will now be discussed. The strain resistant layers comprise, among others, mechanical and thermal characteristics that may resist, for example, damage caused by stress, including, without limitation, thermal and mechanical strain. In certain embodiments, the strain resistant layers may comprise more stable material (e.g., thermally, physically, mechanically, etc.) than rigid insulating layers as described herein. In some embodiments, the strain resistant layers can be more dimensionally stable, for example, under high temperatures, than rigid insulating layers. In some embodiments, the strain resistant layers comprise a material suitable for manufacturing PCBs comprising non-rigid bendable portions, such as, for example, polyester, polyimide, aromatic polyimide, combinations thereof, and the like. In some embodiments, the strain resistant layers can be manufactured from a mixture of the above-mentioned or other materials. In some embodiments, the strain resistant layers comprise resin such as polyimide having one or more of the following characteristics: fully cured, substantially halogen free, non-glass reinforced, substantially lead free, and substantially fiberglass free. In some embodiments, the strain resistant layers comprise resin such as polyimide comprising at least two of the following characteristics: fully cured, substantially halogen free, non-glass reinforced, substantially lead free, and substantially fiberglass free. In some embodiments, the strain resistant layers comprise plastics such as polyimide including a halogen and/or fiberglass. In certain embodiments, the strain resistant layers are substantially free of at least one of the following materials: halogen, fiberglass, and lead. The resistant layers can be substantially free of lead. In one embodiment, the strain resistant layers are substantially free of halogen. In a certain embodiment, the strain resistant layers are substantially free of fiberglass. In some embodiments, the strain resistant layers comprise partially, substantially, or fully cured or uncured polyimide. The strain resistant layers can also comprise material that is at least partially reinforced with some fiberglass.

The strain resistant layers in accordance with embodiments disclosed herein may provide one or more advantages, including when used in connection with rigid PCBs. Strain resistant layers and materials as described herein have not been used with rigid PCBs for several reasons, including higher production costs, lack of availability of various thicknesses and widths, the perceived lack of benefit of characteristics of these materials when used in connection with rigid PCBs comprising non-bending portions, and the like. The Applicant has recognized that certain qualities exhibited by strain resistant materials (e.g., one or more of ductility, hardness, resistance, and the like) can make the strain resistant layers suitable for rigid PCBs as further described herein. For example, strain resistant layers comprising low loss material such as polyimide can dissipate less power along longer lengths than non-low loss materials and can allow for higher density circuits. In another example, strain resistant layers in accordance with various embodiments herein can have higher electrical resistance. Strain resistant layers comprising material having higher electrical resistance can perform better under high temperatures by retaining insulating properties under high temperatures that may degrade insulating qualities of other types of insulating layers (for example, epoxies). The strain resistant layers comprising material having higher electrical resistance, therefore, can help reduce (e.g., minimize, eliminate) electrical failures caused by, among others, insulating layers rendered defective by high temperatures.

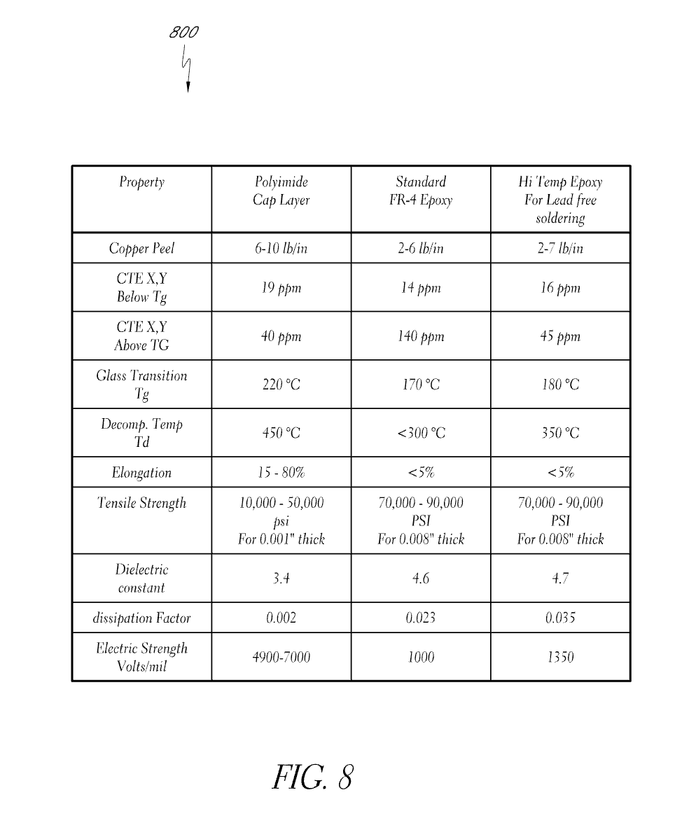

FIG. 8 illustrates various characteristics of example insulating layers. In accordance with various embodiments disclosed herein, strain resistant layers comprising resins such as, without limitation, polyimide or polyimide-based materials can be configured to reduce (e.g., minimize, eliminate), among other defects, pad cratering. FIG. 8 illustrates typical properties for an example strain resistant layer comprising polyimide as well as typical values for FR-4 and High-Temp FR-4 rigid insulating layers. The values in FIG. 8 were obtained using methods in accordance with IPC TM-650 (Association Connecting Electronics Industries Test Method Manual by HIS) and/or ASTM International Standards Worldwide (e.g., ASTM D-190, ASTM D-696, etc.).

As illustrated in FIG. 8, the strain resistant layers, for example comprising polyimide, can be advantageously more ductile than non-strain resistant layers. The ductility (sometimes also referred to as elongation) of an embodiment of a strain resistant layer, for example comprising polyimide, can be in the range of about 15-80%, and also can be about 20%, 25%, 30%, 40%, 45%, 50%, 60%, 65%, 70%, and 75%. In certain embodiments, the strain resistant layer comprises ductility in the range of about 15-20%, 20-30%, 30-40%, 20-60%, 40-80%, 50-80%, 15-35%, and the like. Further still, the strain resistant layers can comprise ductility different from the ranges provided herein, and can comprise ductility less than about 15% (e.g., about 10%), greater than about 80% (e.g., about 90%). In some embodiments, the strain resistant layers comprise ductility of at least about 15%.

The strain resistant layers can comprise higher ductility properties than other insulating materials (for example, ductility of less than 5% for both FR-4 and High-Temp FR-4 epoxies). As previously mentioned, thermal stress resulting from changes in temperature can cause unequal responses (e.g., rates of expansion, contraction, etc.) in insulating and non-insulating layers, including cap layers, of PCBs and other materials (e.g., surface conductive layers, soldering materials, electrical component conductive pads, etc.). In some situations, thermal stress can cause the surface conductive layers of PCBs and cap layers underneath the surface conductive layers to move relative to each other (e.g., in opposite directions, in other directions placing strain on the connection between the cap layers and the surface copper layers, etc.) such that defects such as pad cratering form in or around, among others, the cap layers. The strain resistant layers in accordance with embodiments disclosed herein are more ductile than other insulating layers (e.g., FR-4), and can reduce (e.g., minimize, eliminate) pad cratering by, among others, at least absorbing some of the thermal stress as elastic deformation. Embodiments of strain resistant layers comprising ductile material as disclosed herein can also absorb mechanical stress exerted onto components of PCBs (e.g., cap layers), for example, by other more rigid PCB components such as lead-free soldering material, further reducing the occurring of defects such as pad cratering in the PCB components including in the cap layers.

Although FIG. 8 illustrates characteristics of certain strain resistant layers, including strain resistant layers comprising polyimide (a polyimide cap layer), these values are representative of only the one example of a strain resistant layer and are not a comprehensive representation of all possible strain resistant layers. The various disclosed PCB embodiments can suitably comprise strain resistant layers having different mixtures of polyimide, strain resistant layers comprising other strain resistant materials such as, for example, liquid crystal polymer, train resistant layers comprising mixtures of polyimide and other strain resistant materials, or a combination thereof. In some embodiments, strain resistant layers comprising a different mix of polyimide and/or other materials may have elongation and other properties that are different from FIG. 8 (for example, a strain resistant layer may have a Tg outside the range of about 220-420° C., ductility outside the range of about 15-80%, etc.).

In accordance with certain embodiments disclosed herein, strain resistant layers (e.g., comprising polyimide) can have favorable properties that may reduce (e.g., minimize, eliminate) failures caused by, among others, pad cratering. In particular and as can be seen in FIG. 8, strain resistant layers comprising polyimide can have a Glass Transition Temperature (Tg) range of about 220-420° C., and can also have Tg values of about 240° C., 290° C., 340° C., 390° C., 440° C., and 490° C. In some embodiments, the strain resistant layer comprises Tg values of about 210° C., including Tg values of about 215° C., 230° C., 235° C., 245° C., 250° C., 255° C., 265° C., 270° C., 285° C., 300° C., 305° C., 315° C., 330° C., 350° C., 360° C., 370° C., 375° C., 385° C., 400° C., 405° C., 415° C., 430° C., 445° C., 455° C., 460° C., 470° C., and the like. In certain embodiments, the strain resistant layer comprising material such as polyimide comprise Tg values in the range of about 220-450° C., including about 250-300° C., 300-350° C., 350-400° C., 400-450° C., 450-500° C. and the like. In certain embodiments, the strain resistant layer can comprise Tg values in the range of about 220-230° C., including about 230-240° C., 235-245° C., 245-260° C., 260-280° C., 280-290° C., 290-310° C., 310-320° C., 320-340° C., 340-360° C., 360-370° C., 375-395° C., 400-420° C., 405-415° C., 410-430° C., 430-460° C., 250-350° C., 350-450° C., and the like. Further still, the strain resistant layers can comprise Tg values different from the ranges provided herein, and can comprise Tg less than 220° C. (e.g., 200° C.), greater than 420° C. (e.g., 500° C.), or both. In some embodiments, the strain resistant layers comprise material such as polyimide having Tg of at least 220° C. The strain resistant materials can comprise higher Tg values than other rigid insulating layers (e.g., roughly 170° C. and 180° C. for FR-4 and High-Temp FR-4, respectively.

As illustrated in FIG. 8, the total expansion due to temperature up to solder reflow temperature is lower for a material having higher Tg range (e.g., polyimide) than for a material having a lower Tg (e.g., FR-4). Materials with higher Tg ranges can be advantageous for use as insulating layers, including for use as cap layers in rigid PCBs, because such materials can maintain their dimensional stability (e.g., expand and/or contract less in response to, among others, changes in temperature) over a wider temperature range, potentially reducing the likelihood that cracks will occur in various PCB layers, including cap layers.

As shown in FIG. 8, certain strain resisting layers comprising polyimide comprise Coefficients of Thermal Expansion (CTE), including CTE values in the lateral (X and Y) directions (CTE X,Y) configured to, among others, resist defects such as pad cratering that occur in insulating layers, including cap layers. CTE X,Y values for certain such strain resistant layers can be lower than the CTE X,Y values for other insulating layers, including rigid insulating layers. Materials having lower CTE X,Y characteristics (e.g., polyimide) are more stable than materials having higher CTE X,Y characteristics (e.g., FR-4, High-Temp FR-4) because materials having lower CTE X,Y values generally are less responsive (e.g., expand, contract, etc.) to temperature changes. For example, FIG. 8 illustrates that CTE X,Y for polyimide above the Tg is in the range of about 20 parts per million per ° C. in temperature (ppm/° C.) and about 42 ppm/° C., including CTE X,Y of about 20 ppm/° C., 25 ppm/° C., 30 ppm/° C., 35 ppm/° C., 38 ppm/° C., 39 ppm/° C., 40 ppm/° C., 41 ppm/° C., and 42 ppm/° C. By comparison, FR-4 has a higher CTE X,Y of 140 ppm/° C. and High-Temp FR-4 had a higher CTE X,Y of 45 ppm/° C. Thus, the strain resistant layers comprising polyimide expands less than other insulating layers such as rigid cap layers even under similar temperature conditions, and therefore, the strain resistant layers can reduce thermal forces that apply stress on various components of PCBs, including cap layers.

In certain embodiments, the strain resistant layer comprising material such as polyimide comprise CTE X,Y values in the range of about 15-45 ppm/° C., including about 20-25 ppm/° C., 20-30 ppm/° C., 25-30 ppm/° C., 20-25 ppm/° C., 25-35 ppm/° C., and the like.

Further still, the strain resistant layers can comprise CTE X,Y values different from the ranges provided herein, and can comprise CTE X,Y less than about 20 ppm/° C. (e.g., about 15 ppm/° C.), greater than about 42 ppm/° C. (e.g., about 50 ppm/° C.), or both. In some embodiments, the strain resistant layers comprise material having CTE X,Y of about 45 ppm/° C. or less. The strain resistant materials can also comprise CTE of about 25 ppm/° C. or less, including about 23 ppm/° C., 21 ppm/° C., 19 ppm/° C., 18 ppm/° C., 10 ppm/° C., and the like.

In certain embodiments, the example strain resistant layers comprise CTE, XY characteristics that better match CTE, XY characteristics of other components such as surface copper layers. For example, typical CTE X,Y values for copper and tin-lead solder are around 16 ppm/° C. and 27 ppm/° C., respectively. The CTE X,Y range of about 20 to 42 ppm/° C. (e.g., 25 ppm/° C.) of the example strain resistant layers are closer to the CTE X,Y values of copper and tin-lead than the CTE X,Y values of rigid insulating layers such as FR-4, and therefore, the strain resistant layers and the other components (e.g., surface copper layer) exhibit similar thermal responses under similar thermal conditions (e.g., expand similarly under high temperature). Two layers of different PCB materials (e.g., a cap layer and a surface copper layer) comprising similar thermal coefficients generally exhibit similar thermal behaviors and thus can reduce thermal forces that move one layer relative to the other layer so as to create a defect such as a crack in one layer (e.g., the cap layer). Strain resistant layers comprising CTE values closer to CTE values of surface copper layers than other rigid insulating layers may be more dimensionally stable than the other rigid insulating layers. Thermally matching the strain resistant layers and other materials such as surface copper layers and solder materials can reduce thermal stress on the strain resistant layers (cap layers as shown in FIG. 4) or other insulating layers of PCBs, and the reduced thermal stress may also reduce (e.g., minimize, eliminate) the occurrence of pad cratering in the cap layers or other layers. Further, the strain resistant layers can comprise other material (e.g., inorganic filler) to reduce the difference of CTE between the strain resistant layers and other layers (e.g., surface conductive layers).

The strain resistant layers in accordance with embodiments discloses herein advantageously comprise tensile strength characteristics suited for reducing (e.g., minimizing, eliminating, etc.) damage occurring in, among others, insulating layers such as cap layers. Tensile strength indicates the level at which stress causes sufficient change in the material (e.g., at least partially break, deform, decompose, etc.) such that the change at least interferes with the normal operation of the material and/or the PCB in which the material is located, for example, by causing electrical or mechanical failure. Therefore, insulating layers comprising strain resistant materials having higher tensile strengths perform better because the strain resistant layers can operate under stress levels that otherwise cause defects in materials having lower tensile strengths.

As illustrated in FIG. 8, the strain resistant materials can comprise polyimide having tensile strength in the range of about 10,000-50,000 psi and can include tensile strengths of about 15,000 psi, 20,000 psi, 25,000 psi, 30,000 psi, 35,000 psi, 40,000 psi, 45,000 psi, 50,000 psi, 53,000 psi, etc. In certain embodiments, the strain resistant layer comprising material such as polyimide comprise tensile strength in the range of about 10,000-20,000 psi, including about 25,000-35,000 psi, 35,000-45,000 psi, 15,000-30,000 psi, 25,000-45,000 psi, and the like. Further still, the strain resistant layers can comprise tensile strength values different from the ranges provided herein, and can comprise tensile strength less than about 10,000 psi (e.g., about 5,000 psi), greater than about 50,000 psi (e.g., about 75,000 psi), or both. In some embodiments, the strain resistant layers comprise material such as polyimide having tensile strength of at least about 10,000 psi.

In accordance with certain embodiments, the strain resistant layers comprise strain resistant material having a unique combination of two or more of the aforementioned characteristics (e.g., tensile strength, ductility, CTE X,Y, etc.). Although strain resistant layers comprising, for example, one of the aforementioned characteristics (e.g., ductility) can help reduce or eliminate various defects, strain resistant layers comprising two or more of theses qualities are even more suited to reduce (e.g., minimize, eliminate, etc.) various types of damage, including pad cratering, that occur in insulating layers such as cap layers. For example, the strain resistant layers 450,450a of FIG. 4 comprising two or more of these characteristic (e.g., tensile strength, ductility, CTE X,Y, etc.) are more apt to resist damage such as pad cratering from occurring than other insulating layers comprising, for example, fewer than two of these characteristics.

In accordance with such certain embodiments, the strain resistant layers comprise strain resistant materials having two or more of the following characteristics: ductility in the range of about 15-80%, including about 15-20%, 20-30%, 30-40%, 20-60%, 40-80%, 50-80%, and 15-35%; Tg in range of about 220-420° C., including about 220-250° C., including about 250-300° C., 300-350° C., and 350-400° C.; and tensile strength in the range of about 10,000-50,000 psi, including about 10,000-20,000 psi, 25,000-35,000 psi, 35,000-45,000 psi, 15,000-30,000 psi, 25,000-45,000 psi, and the like.

In accordance with further certain embodiments, the strain resistant layers comprise two or more of the following characteristics: ductility of at least about 15%, including about 20%, 25%, 30%, 40%, 45%, 50%, 60%, 65%, 70%, 75%, and 85%; Tg of at least about 220° C., including about 240° C., 290° C., 340° C., 390° C., 440° C., and 490° C.; and tensile strength of at least about 10,000 psi, including about 15,000 psi, 20,000 psi, 25,000 psi, 30,000 psi, 35,000 psi, 40,000 psi, 45,000 psi, 50,000 psi, and 53,000 psi. In other embodiments, the strain resistant layers comprise two or more of the following characteristics: ductility of at least about 15%; Tg of at least about 220° C.; tensile strength of at least about 10,000 psi; and CTE X,Y of 45 ppm/° C. or less.

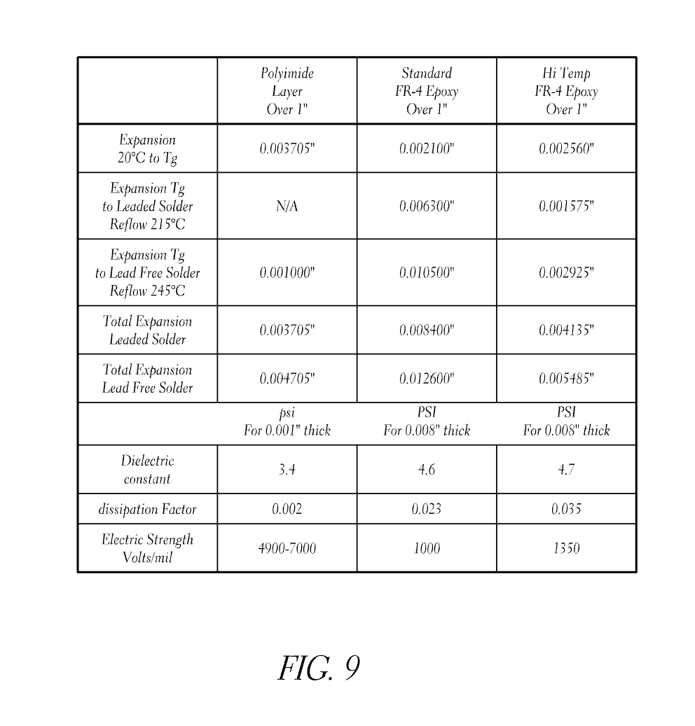

FIG. 9 illustrates Z-axis expansion for example strain resistant layers comprising polyimide relative to similarly sized FR-4 and High-Temp FR-4, all of which having 1 inch (25.4 millimeter) by 1 inch X, Y dimensions. PCBs comprising the various types of insulating layers were subjected to high temperatures during soldering electronic components to the PCBs, for example, about 215° C. during the leaded solder reflow process and 245° C. during the lead-free solder reflow process. At temperatures ranging from 20° C. to Tg, the example strain resistant layer, FR-4, and High-Temp FR-4 expanded by about 0.094107 millimeters (mm), about 0.053340 mm, about 0.065024 mm, respectively. At temperatures ranging from Tg to the leaded solder reflow temperature (215° C.), FR-4 expanded by about 0.160020 mm and High-Temp FR-4 expanded by about 0.040005 mm whereas the example resistant layer expanded by an insignificant amount. For temperatures ranging from Tg to lead-free reflow temperature (245° C.), the example strain resistant layer expanded by about 0.025400 mm, whereas both the FR-4 and the High-Temp FR-4 expanded by higher values of about 0.266700 mm and about 0.074232, respectively. Total expansion for the example strain resistant material for leaded solder reflow was about 0.094107 mm, which was less than each of the total leaded solder reflow expansions of FR-4 and High-Temp FR-4 (about 0.119507 mm and about 0.105029 mm, respectively). Total expansion for the example strain resistant material for lead-free solder reflow was about 0.119507 mm, which was less than each of the total lead free solder reflow expansions of FR-4 and High-Temp FR-4 (about 0.320040 mm and about 0.139319 mm, respectively). In one embodiment, the strain resistant layers comprise aromatic polyimide. As such, cap layers and other insulating layers comprising the strain resistant layers (e.g., polyimide) as disclosed herein can advantageously maintain dimensional stability over a wide temperature range.

Although the foregoing description has shown, described, and pointed out the fundamental novel features of the embodiments disclosed herein, it will be understood that various omissions, substitutions, and changes in the form of the detail of the apparatus as illustrated, as well as the uses thereof, may be made by those skilled in the art, without departing from the spirit or scope of the disclosed embodiments. Consequently, the scope of the present application should not be limited to the foregoing discussion, but should be defined by the appended claims.

What is claimed is:

1. A composition of matter comprising a thermoset resin and a phenoxy resin.

2. The composition of claim 1, wherein the thermoset resin comprises benzoxazine resin.

3. The composition of claim 1, comprising about 5 wt % to about 25 wt % phenoxy resin.

4. The composition of claim 1, comprising about 75 wt % to about 95 wt % thermoset resin.

5. A method of manufacturing the composition of matter of claim 1, comprising:
heating the thermoset resin above its melting temperature;
adding to the liquid thermoset resin a phenoxy resin; and
continuing to heat and blend the mixture until homogeneous.

6. The composition of claim 1, wherein the thermoset resin comprises an uncured benzoxazine resin, the uncured benzoxazine resin being present in the composition in an amount in the range of 75% by weight to 95% by weight based on the total weight of the composition; and the phenoxy resin comprises an uncured phenoxy resin, the uncured phenoxy resin being present in the composition in an amount in the range of 5% by weight to 25% by weight based on the total weight of the composition.

7. The composition of claim 6, wherein the composition further comprises a cured benzoxazine resin, the cured benzoxazine resin being present in an amount in the range of 5% by weight to 25% by weight based on the total weight of the composition.

8. The composition of claim 6, wherein the uncured benzoxazine resin is present in an amount of about 85% or 80% by weight based on the total weight of the composition.

9. An adhesive film layer comprising about 85 wt % benzoxazine resin and about 15 wt % phenoxy resin.

10. A layered film comprising the adhesive film layer of claim 6, further comprising a strain resistant cap layer whose first surface engages the adhesive film layer.

11. The layered film of claim 7, wherein the strain resistant cap layer comprises a polyimide.

12. The layered film of claim 7, further comprising a copper conductive layer's first surface engaging a second surface of the strain resistant cap layer.

13. The layered film of claim 7, further comprising a discardable film layer engaging the second surface of the copper conductive layer.

14. The layered film of claim 10, wherein the discardable film layer comprises polyethylene terephthalate.

15. A component for manufacturing rigid printed circuit boards, the component comprising:
a conductive layer comprising a first surface and a second surface;
a discardable layer comprising a first surface, wherein the first surface of the discardable layer is attached to the first surface of the conductive layer;
a strain resistant layer comprising a first surface, wherein the first surface of the strain resistant layer is attached to the second surface of the conductive layer, and wherein the strain resistant layer comprises at least two characteristics selected from a group of: ductility of at least about 15%, Tg of at least about 220° C., and tensile strength of at least about 10,000 psi; and
an adhesive film layer comprising a first surface, wherein the first surface of the adhesive film layer is attached to the second surface of the strain resistant layer, wherein the adhesive film layer comprises benzoxazine resin and phenoxy resin.

16. The component of claim 12, wherein the discardable layer comprises aluminum.

17. The component of claim 12, wherein the strain resistant layer comprises polyimide.

18. The component of claim 12, wherein the conductive layer comprises copper.

19. The component of claim 12, wherein the conductive layer comprises rolled-annealed copper.

20. The component of claim 12, wherein the strain resistant layer comprises at least one characteristic selected from the group of: fully cured, substantially halogen free, non-glass reinforced, substantially lead free, and substantially fiberglass free.

21. The component of claim 12, wherein the adhesive film layer comprises at least one characteristic selected from the group of: fully cured, substantially halogen free, non-glass reinforced, substantially lead free, and substantially fiberglass free.

22. The component of claim 12, wherein the discardable layer comprises a second surface, and wherein the component further comprises:
a second conductive layer comprising a first surface and a second surface, wherein the first surface of the second conductive layer is attached to the second surface of the discardable layer; and
a second strain resistant layer comprising a first surface, wherein the first surface of the second strain resistant layer is attached to the first surface of the adhesive film layer and the second surface of the adhesive film layer is connected to the second surface of the second conductive layer.

23. The component of claim 19, wherein the second strain resistant comprises at least two of the following characteristics: ductility in the range of about 20-80%; Tg in the range of about 220-420° C.; tensile strength in the range of about 10,000-50,000 psi; and CTE X,Y of about 40 ppm/° C. or less.

24. The component of claim 19, wherein the adhesive film layer has Tg of about 100-300° C.

25. The component of claim 19, wherein the adhesive film layer has CTE X,Y of about 80 ppm/° C. or less.

26. A layered film comprising:
an adhesive film layer comprising,
an uncured benzoxazine resin, the uncured benzoxazine resin being present in the adhesive film layer in an amount in the range of 75% by weight to 95% by weight based on the total weight of the adhesive film layer; and
an uncured phenoxy resin, the uncured phenoxy resin being present in the adhesive film layer in an amount in the range of 5% by weight to 25% by weight based on the total weight of the adhesive film layer.

27. The layered film of claim 26, further comprising a carrier layer comprising a sheet comprising polyester having a surface, wherein the adhesive film layer is disposed on the surface of the sheet comprising polyester.

28. The layered film of claim 27, wherein the sheet comprising polymer comprises polyethylene terephtalate.
